(19) United States
(12) Patent Application Publication
(10) Pub. No.: US 2020/0137944 A1
(43) Pub. Date: May 7, 2020

(54) COMPOSITIONS AND METHODS OF INCREASING SURVIVAL RATE AND GROWTH RATE OF LIVESTOCK

(71) Applicants: Stephen HARRISON, Benicia, CA (US); DryLet, LLC, Houston, TX (US)

(72) Inventors: Mark MENENDEZ, Houston, TX (US); Stephen HARRISON, Benicia, CA (US); M. Scott CONLEY, Cypress, TX (US); Steven R. ELLIS, McKinney, TX (US)

(21) Appl. No.: 16/315,557

(22) PCT Filed: Jul. 6, 2017
(86) PCT No.: PCT/US2017/040974

§ 371 Date: Jan. 4, 2019

Related U.S. Application Data
(60) Provisional application No. 62/359,076, filed on Jul. 6, 2016.

(51) Int. Cl. A01C 3/00; A01K 1/015; C05F 3/00; C05F 11/08; C05F 17/80

(52) U.S. Cl. CPC A01C 3/00; A01K 1/015; C05F 17/80; C05F 3/00; C05F 11/08; A01K 1/0155

(57) ABSTRACT

Methods for increasing growth rate of livestock. Methods for increasing survival rate of livestock. Methods for decreasing hydrogen sulfide concentration in an environment containing manure. Methods for decreasing odor concentration in an environment containing manure. Methods for decreasing ammonia concentration in an environment containing manure. Compositions for decreasing noxious gases in an environment containing manure.

### CROSS-REFERENCE TO RELATED APPLICATIONS

This application is the U.S. National Phase entry of International Application No. PCT/US2017/040974, filed Jul. 6, 2017, which claims priority to U.S. Provisional Application No. 62/359,076 filed Jul. 6, 2016. The contents of the aforesaid applications are incorporated herein by reference in their entireties.

### SUMMARY OF THE INVENTION

Disclosed herein, in certain embodiments, are methods of increasing a growth rate of a plurality of livestock comprising: providing a plurality of livestock and an inert porous medium loaded with at least one microbial species, wherein the plurality of livestock produce a quantity of manure; and applying an effective amount of the inert porous medium loaded with the at least one microbial species to the quantity of manure to increase the growth rate of the plurality of livestock.

In some embodiments, the plurality of livestock comprises pigs, cows, or fowl. In some embodiments, the inert porous medium comprises silica, zeolite, diatomaceous earth, activated alumina, activated carbon, graphite, synthetic polymers, or any combination thereof. In some embodiments, the inert porous medium comprises particles having diameters from about 10 micrometers to about 1400 micrometers. In some embodiments, the inert porous medium comprises pores with an average diameter from about 5 nanometers to about 30 micrometers. In some embodiments, the inert porous medium comprises spherical particles, cylindrical particles, hollow particles, cubic particles, or any combination thereof.

In some embodiments, the inert porous medium loaded with the at least one microbial species is applied to the quantity of manure at a predetermined time interval. In some embodiments, the inert porous medium loaded with the at least one microbial species is applied to the quantity of manure at a ratio from about 0.025 grams-to-cubic meters to about 1.0 kilogram-to-cubic meter.

In some embodiments, the at least one microbial species is combined with a culture media to form a microbial solution and wherein the microbial solution is loaded onto the inert porous medium. In some embodiments, the inert porous medium loaded with the microbial solution has the consistency of a free flowing powder. In some embodiments, the free flowing powder comprises a mass ratio of the inert porous medium to the microbial solution from about 0.25 to about 10.

In some embodiments, the growth rate of the plurality of livestock increases by about 2% to about 4.5%. In some embodiments, a fertilizer or compost is produced by the method.

Disclosed herein, in certain embodiments, are methods of increasing a survival rate of a plurality of livestock comprising: providing a plurality of livestock and an inert porous medium loaded with at least one microbial species, wherein the plurality of livestock produce a quantity of manure; and applying an effective amount of the inert porous medium loaded with the at least one microbial species to the quantity of manure to increase the survival rate of the plurality of livestock.

In some embodiments, the plurality of livestock comprises pigs, cows, or fowl. In some embodiments, the inert porous medium comprises silica, zeolite, diatomaceous earth, activated alumina, activated carbon, graphite, synthetic polymers, or any combination thereof. In some embodiments, the inert porous medium comprises particles having diameters from about 10 micrometers to about 1400 micrometers. In some embodiments, the inert porous medium comprises pores with an average diameter from about 5 nanometers to about 30 micrometers. In some embodiments, the inert porous medium comprises spherical particles, cylindrical particles, hollow particles, cubic particles, or any combination thereof.

In some embodiments, the inert porous medium loaded with the at least one microbial species is applied to the quantity of manure at a predetermined time interval. In some embodiments, the inert porous medium loaded with the at least one microbial species is applied to the quantity of manure at a ratio from about 0.025 grams-to-cubic meters to about 1.0 kilogram-to-cubic meters.

In some embodiments, the at least one microbial species is combined with a culture media to form a microbial solution and wherein the microbial solution is loaded onto the inert porous medium. In some embodiments, the inert porous medium loaded with the microbial solution has the consistency of a free flowing powder. In some embodiments, the free flowing powder comprises a mass ratio of the inert porous medium to the microbial solution from about 0.25 to about 10.

In some embodiments, the survival rate of the plurality of livestock increases by about 0.5% to about 1.1%. In some embodiments, a fertilizer or compost is produced by the methods.

Disclosed herein, in certain embodiments, are methods of decreasing a hydrogen sulfide concentration in an environment containing manure comprising: providing a quantity of manure and an inert porous medium loaded with at least one microbial species; and applying an effective amount of the inert porous medium loaded with the at least one microbial species to the quantity of manure, wherein the inert porous medium loaded with the at least one microbial species decreases the hydrogen sulfide concentration in an environment containing the quantity of manure.

In some embodiments, the method further comprises decreasing the concentration of ammonia, methane, odor, noxious materials, or any combination thereof. In some embodiments, the quantity of manure comprises pig manure, cow manure, or fowl manure.

In some embodiments, the inert porous medium comprises silica, zeolite, diatomaceous earth, activated alumina, activated carbon, graphite, synthetic polymers, or any combination thereof. In some embodiments, the inert porous medium comprises particles having diameters from about 10 micrometers to about 1400 micrometers. In some embodiments, the inert porous medium comprises pores with an average diameter from about 5 nanometers to about 30 micrometers. In some embodiments, the inert porous medium comprises spherical particles, cylindrical particles, hollow particles, cubic particles, or any combination thereof. In some embodiments, the inert porous medium loaded with the at least one microbial species is applied to the quantity of manure at a predetermined time interval. In some embodiments, the inert porous medium loaded with the at least one microbial species is applied to the quantity of manure at a ratio from about 0.025 grams-to-cubic meters to about 1.0 kilogram-to-cubic meter3.

In some embodiments, the at least one microbial species is combined with a culture media to form a microbial solution and wherein the microbial solution is loaded onto the inert porous medium. In some embodiments, the inert porous medium loaded with the microbial solution has the consistency of a free flowing powder. In some embodiments, the free flowing powder comprises a mass ratio of the inert porous medium to the microbial solution from about 0.25 to about 10.

In some embodiments, the hydrogen sulfide concentration in the environment is decreased by about 20% to about 50%. In some embodiments, a fertilizer or compost is produced by the methods.

Disclosed herein, in certain embodiments, are methods of decreasing an odor concentration in an environment containing manure comprising: providing a quantity of manure and an inert porous medium loaded with at least one microbial species; and applying an effective amount of the inert porous medium loaded with the at least one microbial species to the quantity of manure, wherein the inert porous medium loaded with the at least one microbial species decreases the odor concentration in an environment containing the quantity of manure.

In some embodiments, the methods further comprise decreasing the concentration of ammonia, hydrogen sulfide, methane, noxious material, or any combination thereof. In some embodiments, the odor concentration comprises hydrogen sulfide and ammonia. In some embodiments, the quantity of manure comprises pig manure, cow manure, or fowl manure.

In some embodiments, the inert porous medium comprises silica, zeolite, diatomaceous earth, activated alumina, activated carbon, graphite, synthetic polymers, or any combination thereof. In some embodiments, the inert porous medium comprises particles having diameters from about 10 micrometers to about 1400 micrometers. In some embodiments, the inert porous medium comprises pores with an average diameter from about 5 nanometers to about 30 micrometers. In some embodiments, the inert porous medium comprises spherical particles, cylindrical particles, hollow particles, cubic particles, or any combination thereof. In some embodiments, the inert porous medium loaded with the at least one microbial species is applied to the quantity of manure at a predetermined time interval. In some embodiments, the inert porous medium loaded with the at least one microbial species is applied to the quantity of manure at a ratio from about 0.025 grams-to-cubic meters to about 1.0 kilogram-to-cubic meters.

In some embodiments, the at least one microbial species is combined with a culture media to form a microbial solution and wherein the microbial solution is loaded onto the inert porous medium. In some embodiments, the inert porous medium loaded with the microbial solution has the consistency of a free flowing powder. In some embodiments, the free flowing powder comprises a mass ratio of the inert porous medium to the microbial solution from about 0.25 to about 10.

In some embodiments, the odor concentration in the environment is decreased by about 20% to about 60%. In some embodiments, a fertilizer or compost is produced by the methods.

Disclosed herein, in certain embodiments, are methods of decreasing an ammonia concentration in an environment containing manure comprising: providing a quantity of manure and an inert porous medium loaded with at least one microbial species; and applying an effective amount of the inert porous medium loaded with the at least one microbial species to the quantity of manure, wherein the inert porous medium loaded with the at least one microbial species decreases the ammonia concentration in an environment containing the quantity of manure.

In some embodiments, the methods further comprises decreasing the concentration of hydrogen sulfide, methane, odor, noxious material, or any combination thereof. In some embodiments, the quantity of manure comprises pig manure, cow manure, or fowl manure.

In some embodiments, the inert porous medium comprises silica, zeolite, diatomaceous earth, activated alumina, activated carbon, graphite, synthetic polymers, or any combination thereof. In some embodiments, the inert porous medium comprises particles having diameters from about 10 micrometers to about 1400 micrometers. In some embodiments, the inert porous medium comprises pores with an average diameter from about 5 nanometers to about 30 micrometers. In some embodiments, the inert porous medium comprises spherical particles, cylindrical particles, hollow particles, cubic particles, or any combination thereof. In some embodiments, the inert porous medium loaded with the at least one microbial species is applied to the quantity of manure at a predetermined time interval. In some embodiments, the inert porous medium loaded with the at least one microbial species is applied to the quantity of manure at a ratio from about 0.025 grams-to-cubic meters to about 1.0 kilogram-to-cubic meters.

In some embodiments, the at least one microbial species is combined with a culture media to form a microbial solution and wherein the microbial solution is loaded onto the inert porous medium. In some embodiments, the inert porous medium loaded with the microbial solution has the consistency of a free flowing powder. In some embodiments, the free flowing powder comprises a mass ratio of the inert porous medium to the microbial solution from about 0.25 to about 10.

In some embodiments, the concentration of ammonia in the environment is decreased by about 15% to about 30%. In some embodiments, a fertilizer or compost is produced by the methods.

Disclosed herein, in certain embodiments, are compositions comprising a quantity of manure and an inert porous medium loaded with at least one microbial species, wherein the quantity of manure has a decreased concentration of noxious materials.

In some embodiments, the noxious materials comprise ammonia, hydrogen sulfide, methane, carbon dioxide, nitrous oxide, odors, toxins, or any combinations thereof. In some embodiments, the quantity of manure comprises pig manure, cow manure, or fowl manure. In some embodiments, the inert porous medium comprises silica, zeolite, diatomaceous earth, activated alumina, activated carbon, graphite, synthetic polymers, or any combination thereof. In some embodiments, the inert porous medium comprises particles having diameters from about 10 micrometers to about 1400 micrometers. In some embodiments, the inert porous medium comprises pores with an average diameter from about 5 nanometers to about 30 micrometers. In some embodiments, the inert porous medium comprises spherical particles, cylindrical particles, hollow particles, cubic particles, or any combination thereof. In some embodiments, the inert porous medium loaded with the at least one microbial species is applied to the quantity of manure at a predetermined time interval. In some embodiments, the inert porous medium loaded with the at least one microbial species is applied to the quantity of manure at a ratio from about 0.025 grams-to-cubic meters to about 1.0 kilogram-to-cubic meters.

In some embodiments, the at least one microbial species is combined with a culture media to form a microbial solution and wherein the microbial solution is loaded onto the inert porous medium. In some embodiments, the inert porous medium loaded with the microbial solution has the consistency of a free flowing powder. In some embodiments, the free flowing powder comprises a mass ratio of the inert porous medium to the microbial solution from about 0.25 to about 10.

In some embodiments, the concentration of noxious gas is decreased by about 15% to about 75%. In some embodiments, the composition is a fertilizer or compost.

Disclosed herein, in certain embodiments, are methods of decreasing foaming in an environment containing manure comprising: providing a quantity of manure and an inert porous medium loaded with at least one microbial species; and applying an effective amount of the inert porous medium loaded with the at least one microbial species to the quantity of manure, wherein the inert porous medium loaded with the at least one microbial species decreases foaming in an environment containing the quantity of manure.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a flow diagram of an experimental system.

FIG. 2 is a schematic representation of a manure reactor experimental system.

FIG. 3 is the odor concentration measured on days 24 and 42 by a human olfactometry panel.

FIG. 4 is the average odor concentration for control and treated reactors.

FIG. 5 is the average hydrogen sulfide concentration of treated and untreated manure.

FIG. 6 is the mass of hydrogen sulfide emitted from treated and untreated manure over time.

FIG. 7 is a schematic representation of day zero of an experimental setup.

FIG. 8 is a schematic representation of days one through six of an experimental setup.

FIG. 9 is the ammonia concentration as a function of day for manure treated with a liquid control.

FIG. 10 is the ammonia concentration as a function of day for manure treated with ManureMagic® and other nitrifying microorganisms (mixed community 1).

FIG. 11 is the ammonia concentration as a function of day for manure treated with ManureMagic® and other nitrifying microorganisms (mixed community 2).

FIG. 12 is the ammonia concentration as a function of day for manure treated with ManureMagic® and other nitrifying microorganisms (mixed community 3).

FIG. 13 is a summary of the percent reduction in ammonia concentration.

FIG. 14 is foam height as a function of day for control and treated barns.

FIGS. 15A and 15B are foaming capacity and foaming stability for control samples, samples treated with ManureMagic®, and samples treated with Narasin.

FIGS. 16A-16D are the initial and ending ammonia concentrations for control samples and samples treated with mixed communities 1-3.

FIG. 17 is a summary of the percent changes in ammonia concentration from day zero to day six of the study.

### DETAILED DESCRIPTION OF THE INVENTION

Economic factors driving the production of meat demand that healthy meat be produced as efficiently as possible. Major cost components of livestock production are feed and initial youngling purchase. The efficiency of feed conversion and increased survival of the initial population are vital to the economic success. Efficient production of end products such as meat and milk requires implementation of both genetic and management techniques. For example, the genotype of an animal determines the maximum level at which meat production can occur, whereas management factors such as health status, quality of feed, ambient temperature, presence of bioproducts, ambient air, and pen density contribute to the biological efficiency of the animal. Factors affecting quality of the environment also include amount of airborne dust, humidity, microorganisms, noxious gases, and toxins that are present during life of the livestock from birth to slaughter. Managing the environment leads to marked increases in daily gain and feed conversion, so there is need to identify and utilize compositions that can address several of the environmental issues at the same time.

Emissions of odor and gases from animal production have created ecological, environmental, safety, meat quality, and production efficiency concerns. Over the last many years, modern livestock production facilities became much larger with a greater concentration of animals in a given area and the trend continues today. Public scrutiny and state and local regulations of livestock operations are increasing. Most complaints associated with animal confinement operations are related to odor. It is thought by most people that reductions in odor emitted to the surroundings would increase the public acceptance of animal production operations. Workers at livestock production facilities in the U.S. spend most of their time exposed to hydrogen sulfide (H₂S), ammonia (NH₃), and other noxious gases which have negative effects on their health. The facilities also emit significant amounts of greenhouse gases including carbon dioxide (CO₂), methane (CH₄), and nitrous oxide (N₂O). The combination of these and hundreds of volatile organic compounds (VOC) create offensive odor perceived downwind of the facilities. Ammonia is released from manure as it chemically and biologically breaks down. Chronic exposure to NH₃ is the most common hazardous gas to which livestock workers are exposed. The National Institute for Occupational Safety and Health recommends an average daily exposure threshold of 25 ppm. The highest ammonia concentrations near farms, feedlots, and manure applications may range from 0.28 to 88 ppm, according to a study. Hydrogen sulfide, which is heavier than air, can accumulate to high levels in manure pits, is produced by anaerobic fermentation and is toxic to humans and deadly at high concentrations. Concentrations increase during any planned or unplanned disturbances of stored manure in deep pits and the levels can become fatal. Hydrogen sulfide adds significantly to the human perception of odor from these operations. Acute exposures to toxic or asphyxiating manure gases released may occur during planned and unplanned manure disturbances, especially in buildings with deep pits, which are commonplace in swine buildings throughout the US Midwest.

Disclosed herein are compositions containing microorganisms, methods of making these compositions, and methods of using these compositions in the environment of the livestock to increase the growth rate and survival rate of livestock. In some embodiments, advantages of the methods and compositions include increased rate of weight gain of the livestock in treated environments based on the same amount of feed, enabling the livestock to be suitable for sale faster, and reduction of the production cycle.

### Certain Definitions

The terminology used herein is for the purpose of describing particular cases only and is not intended to be limiting. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The term “about” or “approximately” means within an acceptable error range for the particular value as determined by one of ordinary skill in the art, which will depend in part on how the value is measured or determined, e.g., the limitations of the measurement system. For example, “about” can mean within 1 or more than 1 standard deviation, per the practice in the given value. Where particular values are described in the application and claims, unless otherwise stated the term “about” should be assumed to mean an acceptable error range for the particular value.

As used herein, the phrase “inert porous medium” refers to an inert support having a porous structure. In some embodiments, the inert porous medium is silica, precipitated silica granules, super absorbent silica polymers, crystalline silica, fused quartz, fumed silica, silica gels, aerogels, colloidal silica, zeolite, aluminosilicate, silicate, activated carbon, diatomaceous earth, synthetic polymers, alumina, graphite, grain fibers, walnut and pecan shells, rice hulls, cellulosic clay, montmorillonite clay, bentonite clay, wool, cotton, cellulose, corn cobs, cellulose shells, and combinations thereof. In some embodiments, zeolite comprises andalusite, kyanite, sillimanite, analcime, chabazite, clinoptilite, mordenite, natrolite, heulandite, phillipsite, or stilbite. In some embodiments, the inert porous medium includes spherical particles, cylindrical particles, cubic particles, rectangular particles, hollow particles, flakes, granules, or any combinations thereof. In some embodiments, the inorganic porous medium is a mixture of different types of inorganic porous mediums. In some embodiments, the porous structure is loaded with least one microbial species. In some embodiments, the porous structure is loaded with multiple microbial species.

As used herein, “delivered microorganism composition” refers to bacteria, viruses, mycoplasma, fungi, and protozoa loaded onto an inert porous medium. In some embodiments, the microorganism loaded onto the inert porous medium is bacteria. In some embodiments, the microorganisms include a single species of microorganism or a consortium of microorganisms. In some embodiments, the microorganism(s) are selected based on intended use or the available nutrient sources.

As used herein, the term “dry mode” means that a liquid is substantially loaded into the inert porous medium. In some embodiments, dry mode is achieved during the mixing process when a liquid is loaded into the inert porous medium. In some embodiments, the liquid is a liquid culture of microorganisms. In some embodiment, after mixing for five minutes, the resulting product is dry to the touch and can be handled as a dry product. Furthermore, the dry product is fully free flowing.

As used herein, the term “survival rate” means percentage of livestock in a group that are alive over a given time period. In some embodiments, the survival rate is measured as the percentage of livestock in a group that are alive at the time of commercial consumption. For example, if piglets in a cohort are allowed to grow under similar environmental conditions until the day of desired weight for sale for pork production, then the survival rate is determined as the percentage of pigs alive on that day as compared to the initial number of piglets in the cohort. In some embodiments, the survival rate accounts for the loss of animals due to sickness, injury, and death.

As used herein, the term “growth rate” means weight gain of an animal over a given time period. In some embodiments, the growth rate is obtained dividing how much weight the animal has gained by the period of time spent to accomplish it.

As used herein, the term “manure” means any excreta from livestock. In some embodiments, the manure includes excreta present in combination with other materials such as straw, litter, or other bedding material. In some embodiments, the manure includes excreta present in combination with other residues from fodder fed to the livestock. In some embodiments, the manure is decomposed materials from the solid and fluid excreta.

As used herein, the term “effective amount” of the compositions described herein means at least the amount of the specific composition required to bring about the desired changes in the livestock or in the environment of the livestock.

### Compositions for Use With Livestock Manure

Disclosed herein, in some embodiments, are compositions for use with livestock manure.

In some embodiments, the compositions used herein contain an inert porous medium loaded with microorganisms. In some embodiments, the inert porous medium is made up of one or more of silica, precipitated silica granules, super absorbent silica polymers, crystalline silica, fused quartz, fumed silica, silica gels, aerogels, colloidal silica, zeolite, aluminosilicate, silicate, carbon, activated carbon, diatomaceous earth, synthetic polymers, alumina, graphite, walnut and pecan shells, rice hulls, cellulosic clay, montmorillonite clay, bentonite clay, wool, cotton, cellulose, corn cobs, cellulose shells, and combinations thereof. In some embodiments, the inert porous medium includes compositions made of silicon dioxide. In some embodiments, the inert porous medium is precipitated silica or precipitated silica granules. In some embodiments, precipitated silica is highly porous and contains a large surface area both within their volume and on the surface. In some embodiments, one pound of silica has approximately 700,000 square feet of surface area. In some embodiments, the surface area provides a matrix upon which a reaction can be accelerated. In some embodiments, precipitated silica is also a super absorbent polymer capable of drawing in organic nutrients to be used as building blocks for new bacterial cells and to sustain cellular functions. In some embodiments, the zeolite comprises, but is not limited to, andalusite, kyanite, sillimanite, analcime, chabazite, clinoptilite, mordenite, natrolite, heulandite, phillipsite, or stilbite. In some embodiments, is made of carbonaceous materials, such as activated carbon, graphite, and granulated activated carbon. In some embodiments, the inert porous medium is made of aluminosilicate alumina or activated alumina. In some embodiments, the inert porous medium is made of spherical particles, cylindrical particles, cubic particles, rectangular particles, hollow particles, granules, flakes, or any combination thereof.

In some embodiments, a composition for use with livestock manure includes an inert porous medium loaded with microorganisms. In some embodiments, the inert porous medium is operable for delivering the microorganisms in a dry mode. In some embodiments, the inert porous medium has a porous structure throughout the medium. In some embodiments, the inert porous medium is a hollow particle with a porous shell. In some embodiments, the microbial species is loaded on the surface of the inert porous medium, in the pores, or throughout the inert porous medium. In some embodiments, the inert porous medium has a surface area ranging from about 140 square meters per gram (m²/g) to about 160 m²/g. Examples of inert porous medium include precipitated silica granules such as the FLO-GARD® or HI-SIL® silicon dioxide products obtained from PPG Industries, Inc.

In some embodiments, the inert porous medium comprises particles having diameters from about 10 micrometers to about 1400 micrometers. In some embodiments, the particles have diameters of less than about 2000 micrometers, less than about 1750 micrometers, less than about 1500 micrometers, less than about 1250 micrometers, less than about 1000 micrometers, less than about 750 micrometers, less than about 500 micrometers, less than about 250 micrometers, less than about 100 micrometers, less than about 50 micrometers, less than about 10 micrometers, or less. In some embodiments, the inert porous medium comprises pores with an average diameter from about 5 nanometers to about 30 micrometers. In some embodiments, the inert porous medium comprises pores with an average diameter of less than about 100 micrometers, less than about 50 micrometers, less than about 25 micrometers, less than about 10 micrometers, less than about 5 micrometers, less than about 1 micrometer, less than about 750 nanometers, less than about 500 nanometers, less than about 250 nanometers, less than about 100 nanometers, less than about 75 nanometers, less than about 50 nanometers, less than about 25 nanometers, less than about 10 nanometers, less than about 5 nanometers, or less.

In some embodiments, microorganisms loaded into the inert porous medium include at least one microbial species. In some embodiments, the at least on microbial species includes a liquid culture of microorganisms. In some embodiments, microorganisms loaded into the inert porous medium include a consortium of microbial species. In some embodiments, the microbial species is a bacteria, fungi, algae, plankton, planaria, protist, protozoan, or a combination thereof. In some embodiments, the microbial species comprises a native, non-pathogenic microbial species. In some embodiments, the microbial species comprises a genetically modified microbial species.

Examples of bacteria include without limitations: bacillus, prokaryotes and eukaryotes, gram positive and gram negative, Actinobacteria, Firmicutes, Tenericutes, Aquificae, Bacteroidetes/Chlorobi, Chlamydiae/Verrucomicrobia, Deinococcus-Thermus, Fusobacteria, Gemmatimonadetes, Nitrospirae, Proteobacteria, Spirochaetes, Synergistetes, Acidobacteria, Chloroflexi, Chrysiogenetes, Cyanobacteria, Deferribacteres, Dictyoglomi, Fibrobacteres, Planctomycetes, Thermodesulfobacteria, Thermotogae, B. alvei, B. amyloliquefaciens, B. anthraces, B. cereus, B. circulars, B. coagulans, B. globigii, B. infernus, B. larvae, B. laterosporus, B. licheniformis, B. megaterium, B. mucilaginosus, B. natto, B. polymyxa, B. pseudoanthracis, B. pumilus, B. sphaericus, B. sporothermodurans, B. stearothermophilus, B. subtilis, B. thuringiensis, and combinations thereof.

Examples of bacteria include without limitations: pseudomonads, flavobacteriaceaes, and bacillus, Pseudomonas fluorescence, Pseudomonas aeruginosa, Pseudomonas putida, Pseudomonas alcoligenes, Flavobacterim, Arthrobacter cumminsii, Alconivorax borkumensis, Vibrio parahaemolyticus, and combinations thereof.

Examples of fungi include without limitations: Blastocladiomycota, Chytridiomycota, Glomeromycota, Microsporidia, Neocallimastigomycota, Dikarya, Deuteromycota, Ascomycota, Pezizomycotina, Saccharomycotina, Taphrinomycotina, Basidiomycota, Agaricomycotina, Pucciniomycotina, Ustilaginomycotina, Subphyla Incertae sedis, Entomophthoromycotina, Kickxellomycotina, Mucoromycotina, Zoopagomycotina, and combinations thereof.

Examples of algae include without limitations: Archaeplastida, Chlorophyta, Rhodophyta, Glaucophyta, Rhizaria, Excavata, Chlorarachniophytes, Euglenids, Chromista, Alveolata, Heterokonts, Bacillariophyceae, Axodine, Bolidomonas, Eustigmatophyceae, Phaeophyceae, Chrysophyceae, Raphidophyceae, Synurophyceae, Xanthophyceae, Cryptophyta, Dinoflagellates, Haptophyta, and combinations thereof.

Examples of plankton include without limitations: phytoplankton, autotrophic, prokaryotic or eukaryotic algae, cyanobacteria, dinoflagellates and coccolithophores, zooplankton, small protozoans or metazoans, bacterioplankton, and combinations thereof.

Examples of planaria include without limitations: Dugesia tigrina, Planaria maculate, Dugesia dorotocephala, Schmidtea mediterranea, and combinations thereof.

Examples of protists include without limitations: Chromalveolata, Heterokontophyta, Haptophyta, Cryptophyta, Alveolata, Dinoflagellata, Apicomplexa, Ciliophora, Excavata, Euglenozoa, Percolozoa, Metamonada, Rhizaria, Radiolaria, Foraminifera, Cercozoa, Archaeplastida, Rhodophyta, Glaucophyta, Unikonta, Amoebozoa, Choanozoa, and combinations thereof.

In some embodiments, compositions contain bacteria modified for performing certain desired conversions. For example, the ManureMagic® composition has been formulated to contain one or more types of bacteria from the genus Bacillus. In some embodiment, compositions include members of the genera Brevibacillus, Paenibacillus, and combinations thereof. In some embodiments, compositions include methanotrophs, autotrophic anaerobes, ammonia-oxidizing bacteria, nitrite-oxidizing bacteria, and combinations thereof. In some embodiments, compositions include, but are not limited to, Bacillus aryabhattai, Bacillus mucilaginosus, Brevibacillus choshinensis, Bacillus pumilus, Bacillus megaterium, Bacillus subtilis, Bacillus cereus, Bacillus safensis, Paenibacillus azoreducens, and others.

In some embodiments, the inert porous medium loaded with the microbial species additionally comprises nutrients necessary for growth of the microbial species. In some embodiments, the nutrients comprise organic nutrients, inorganic nutrients, or combinations thereof. In some embodiments, the nutrients comprise nitrate, ammonium, phosphate, calcium, potassium, sulfur, or a combination thereof.

In some embodiments, the inert porous material is loaded with a mixture of microbial species. In some embodiments, compatible microbial mixtures containing different species are loaded on the inert porous medium and are used to change the microbial environment at the site of their application. In some embodiments, the specific combinations of microbial mixtures are tailored to address different remediation requirements. In some embodiments, the microbial mixtures include at least 2, at least 3, at least 4, at least 6, at least 8, at least 10, at least 15, at least 20, or more different microbial species. In some embodiments, microbial mixtures comprise at least about 50%, at least about 60%, at least about 70%, at least about 80%, at least about 90%, at least about 95%, at least about 99%, or more selected microorganisms. In some embodiments, microbial mixtures contain less than about 50%, less than about 40%, less than about 30%, less than about 20%, less than about 10%, less than about 5%, less than about 1%, or less non-selected, naturally occurring, or other microorganisms. In some embodiments, remediation requirements include decreased odor, decreased concentrations of hydrogen sulfide, decreased concentrations of ammonia, decreased concentrations of toxins, decreased concentrations of noxious gases, or any combination thereof. In some embodiments, remediation requirements include changing the texture, microbial composition, or chemical composition of the manure.

In some embodiments, normally incompatible microbial species are combined safely in a desired environment by loading the species separately onto the inert porous medium. In some embodiments, the normally incompatible microbial species are loaded into different batches of inert porous medium and combined into a single batch for storage. In some embodiments, incompatible microbial species are loaded into separate batches of inert porous medium, stored separately, and combined during addition to the livestock manure. In some embodiments, multiple batches of inert porous medium loaded with different microbial species are added to the livestock manure. In some embodiments, multiple batches of inert porous medium loaded with different microbial species includes at least 2, at least 3, at least 4, at least 6, at least 8, at least 10, at least 15, at least 20 batches, or more batches of inert porous medium containing microbial species. In some embodiments, a batch comprises a single microbial species loaded onto an inert porous medium. In some embodiments, a batch comprises a mixture of microbial species loaded onto an inert porous medium.

In some embodiments, the inert porous medium and the at least one microbial species are combined to form a composition in a dry mode. In some embodiments, the dry mode composition has the consistency of a free flowing powder. In some embodiments, the microbial species is combined with a culture media or a liquid culture media. In some embodiments, the microbial species and culture media or liquid culture media are combined to form a microbial solution. In some embodiments, the microbial solution is loaded onto the inert porous medium to form a free flowing powder. In some embodiments, the free flowing powder comprises a mass ratio of inert porous medium to microbial solution from about 0.25 to about 10. In some embodiments, the mass ratio of inert porous medium to microbial solution is less than about 10, less than about 8, less than about 6, less than about 4, less than about 2, less than about 1, less than about 0.75, less than about 0.5, less than about 0.25, or less.

In some embodiments, the shelf life of the dry mode composition is longer than the shelf life of the microbial species in absence of the inert porous medium. In some embodiments, the shelf life of the dry mode composition is about 1 month, 2 months, 3 months, 4 months, 5 months, 6 months, 7 months, 8 months, 9 months, 10 months, 11 months, 1 year, 1.5 years, 2 years, or more than 2 years. As used herein, shelf life generally means the recommendation of time that products can be stored, during which the defined quality of a specified proportion of the goods remains acceptable under expected (or specified) conditions of distribution, storage and display. Some substances in their fluid states are relatively unstable.

### Methods for Treating Livestock Manure

Disclosed herein, in some embodiments, are methods for increasing the growth rate of livestock comprising: (a) providing livestock and an inert porous medium loaded with at least one microbial species, wherein the livestock produce a quantity of manure; and (b) applying an effective amount of the inert porous medium loaded with the at least one microbial species to the quantity of manure to increase the growth rate of the livestock.

In some embodiments, the growth rate of the livestock is determined by dividing total amount of weight an animal has gained by the time it takes to gain the weight. In some embodiments, the growth rate is at least about 0.25, at least about 0.5, at least about 0.75, at least about 1, at least about 1.25, at least about 1.5, at least about 1.75, at least about 2, or more pounds per day (lbs/day). In some embodiments, the growth rate is between about 0.25 and 2, between about 0.5 and 1.75, between about 0.75 and 1.5, or between about 1 and 1.25 lbs/day. In some embodiments, the growth rate is between about 1.05 and 1.15 lbs/day. In some embodiments, the growth rate is increased by at least about 0.25%, at least about 0.5%, at least about 0.75%, at least about 1%, at least about 1.25%, at least about 1.5%, at least about 2%, at least about 2.5%, at least about 3%, at least about 4%, least about 5%, at least about 10%, or more as compared to livestock in a non-treated manure environment. In some embodiments, the growth rate is increased from about 0.25% to about 10%, from about 0.5% to about 5%, from about 0.75% to about 4%, from about 1% to about 3%, from about 1.5% to about 2% as compared to livestock in a non-treated manure environment. In some embodiments, the growth rate is increased from about 2% to about 5% as compared to livestock in a non-treated manure environment.

Disclosed herein, in some embodiments, are methods for increasing a survival rate of livestock comprising: (a) providing livestock and an inert porous medium loaded with at least one microbial species, wherein the livestock produce a quantity of manure; and (b) applying an effective amount of the inert porous medium loaded with the at least one microbial species to the quantity of manure to increase the survival rate of the livestock.

In some embodiments, the survival rate is the percentage of livestock in a group that are alive over a given time. In some embodiments, the survival rate is at least about 80%, at least about 85%, at least about 90%, at least about 95%, at least about 98%, at least about 99%, or more. In some embodiments, the survival rate is increased by at least about 0.25%, at least about 0.5%, at least about 0.75%, at least about 1%, at least about 1.25%, at least about 1.5%, at least about 1.75%, at least about 2%, at least about 2.5%, at least about 5%, or more as compared to livestock in a non-treated manure environment. In some embodiments, the survival rate is increased from about 0.25% to about 5%, from about 0.5% to about 2.5%, from about 1% to about 2% as compared to livestock in a non-treated manure environment. In some embodiments, the survival rate is increased from about 0.5% to about 1.25%.

In some embodiments, the livestock is cattle, swine, sheep, goat, rabbit, llama, horse, poultry, or a combination thereof. In some embodiments, livestock manure is treated with a composition that includes an inert porous medium loaded with at least one microbial species. In some embodiments, the manure treated with a composition that includes an inert porous medium loaded with at least one microbial species is used as a fertilizer or compose. In some embodiments, compositions include anaerobic acting species, such as the anaerobic ammonium oxidation (anammox) bacteria, to reduce ammonia formation. In some embodiments, other compositions include bacterial species that can reduce hydrogen sulfide, reduce methane, and reduce odors. In some embodiments, the bacterial species is adsorbed separately on the inert porous medium and delivered together. In some embodiments, a single delivered microorganism is employed. In some embodiments, multiple delivered microorganisms are employed. In some embodiments, the delivered microorganisms are delivered in the same time interval or during different time intervals. In some embodiments, these compositions are delivered together to a site to reduce ammonia, hydrogen sulfide, methane, and other noxious and odorous compounds in the environment.

In some embodiments, the delivered microorganism compositions are applied before, during, or after exposure of an environment to livestock manure. In some embodiments, the delivered microorganism compositions are applied before, during, and after exposure of an environment to livestock manure. In some embodiments, the delivered microorganism compositions are applied at a predetermined time interval. In some embodiments, the delivered microorganism compositions are applied at least once every 0.5, 1, 2, 4, 6, 8, 10, 15, 20, 30, 40, 50, 75, 100, 150, 200, 250, 300, 350, 400, or more days as required to maintain viable microbial activity. In some embodiments, the delivered microorganism compositions are applied at a ratio of at least about 0.02, at least about 0.05, at least about 0.1, at least about 0.2, at least about 0.5, at least about 1, at least about 10, at least about 50, at least about 100, at least about 500, at least about 1000, or more grams of delivered microorganism composition to cubic meter of manure.

In some embodiments, the delivered microorganisms are applied to an environment containing livestock manure. In some embodiments, the environment includes manure pits, manure lagoons, slaughter house waste and drains, livestock barns, livestock sheds, earth basins, manure tanks, or any combinations thereof.

In some embodiments, the housing for the livestock is treated with the composition on a periodic basis. In an exemplary embodiment, three lagoons in a swine production unit are treated with seven pails each of the delivered microorganism composition. The delivered microorganism composition is placed into pails with 3-5 scoops (each scoop is about 0.25 pounds) in each pail, and then water was added to create a slurry. This slurry is then poured down a 2 inch PVC pipe that is been placed into the lagoon deep enough to be below a crust on the lagoon surface.

In another exemplary embodiment of a pit-based operation, 250 grams (g) of the delivered microorganism composition is placed into a pail and water is added to enable a more uniform distribution of the delivered microorganism composition in each pit. In some embodiments, the pits are partially or fully emptied every two weeks. In some embodiments, the compositions disclosed herein are added the pit every time the full pit is emptied or every other time the pit is partially emptied. In some embodiments, data is collected daily on air quality in the barns. In some embodiments, feed conversion data is analyzed for each barn at the appropriate time to determine the impact of an improved animal environment within the barn.

In an exemplary embodiment, the composition is applied as follows for a pork processing facility. In some embodiments, about three pounds of the delivered microorganism composition is spread on to the floor drains in the wet areas of the pork processing facility daily (when the plant is processing pigs). In some embodiments, the compositions are spread across as many of the floor drains as possible to insure that all the drain lines are getting the delivered microorganism composition into the pipes. In some embodiments, this requires rotating the drains treated every other day. In some embodiments, the normal daily water quality measurements for discharge are tracked, and the sludge volumes that end up in the drying containment area are recorded.

### Compositions and Methods for Decreasing Noxious Gases and Toxins in Livestock Manure

Disclosed herein, in some embodiments, are methods for decreasing hydrogen sulfide concentration in an environment containing manure comprising: (a) providing a quantity of manure and an inert porous medium loaded with at least one microbial species; and (b) applying an effective amount of the inert porous medium loaded with the at least one microbial species to the quantity of manure, wherein the inert porous medium loaded with the at least one microbial species decreases the hydrogen sulfide concentration in an environment containing the quantity of manure.

In some embodiments, methods for decreasing hydrogen sulfide concentration also decrease the concentrations of ammonia, methane, odors, noxious materials, or any combination thereof. In some embodiments, the at least one microbial species comprises any hydrogen sulfide reducing microorganism. In some embodiments, the at least one microbial species comprises a mixture of different microbial species that reduce hydrogen sulfide. In some embodiments, the mixture of microbial species includes microorganisms that reduce ammonia, methane, odor, and/or noxious materials in the manure and the environment containing the manure.

In some embodiments, the hydrogen sulfide concentration is less than about 500 part per million by volume (ppmv), less than about 100 ppmv, less than about 50 ppmv, less than about 10 ppmv, less than about 5000 parts per billion by volume (ppbv), less than about 1000 ppbv, less than about 500 ppbv, less than about 100 ppbv, or less. In some embodiments, the hydrogen sulfide concentration is decreased by at least about 5%, at least about 10%, at least about 15%, at least about 20%, at least about 25%, at least about 30%, at least about 40%, at least about 50%, at least about 60%, or more as compared to non-treated manure. In some embodiments, the hydrogen sulfide concentration is decreased from about 5% to about 60%, from about 10% to about 50%, from about 15% to about 40%, from about 20% to about 30% as compared to non-treated manure.

Disclosed herein, in some embodiments, are methods for decreasing odor concentration in an environment containing manure comprising: (a) providing a quantity of manure and an inert porous medium loaded with at least one microbial species; and (b) applying an effective amount of the inert porous medium loaded with the at least one microbial species to the quantity of manure, wherein the inert porous medium loaded with the at least one microbial species decreases the odor concentration in an environment containing the quantity of manure.

In some embodiments, methods for decreasing odor concentration also decrease the concentrations of ammonia, methane, hydrogen sulfide, noxious materials, or any combination thereof. In some embodiments, the microbial species comprises any odor reducing microorganism. In some embodiments, the microbial species is a mixture of different microbial species that reduce odor. In some embodiments, the mixture of microbial species includes microorganisms that reduce ammonia, methane, hydrogen sulfide, noxious materials, or any combinations thereof in the manure and the environment containing the manure.

In some embodiments, the odor concentration is less than about 20,000 odor units per cubic meter (OU/m³), less than about 10,000 OU/m³, less than about 5,000 OU/m³, less than about 2,500 OU/m³, less than about 1,000 OU/m³, or less. In some embodiments, the odor concentration is decreased by at least about 5%, at least about 10%, at least about 15%, at least about 20%, at least about 25%, at least about 30%, at least about 40%, at least about 50%, at least about 60%, at least about 70%, or more as compared to non-treated manure. In some embodiments, the odor concentration is decreased from about 5% to about 70%, from about 10% to about 60%, from about 15% to about 40%, or from about 20% to about 30% as compared to non-treated manure.

Disclosed herein, in some embodiments, are methods for decreasing ammonia concentration in an environment containing manure comprising: (a) providing a quantity of manure and an inert porous medium loaded with at least one microbial species; and (b) applying an effective amount of the inert porous medium loaded with the at least one microbial species to the quantity of manure, wherein the inert porous medium loaded with the at least one microbial species decreases the ammonia concentration in an environment containing the quantity of manure.

In some embodiments, methods for decreasing ammonia concentration also decrease the concentrations of hydrogen sulfide, methane, odor, noxious materials, or any combination thereof. In some embodiments, the at least one microbial species comprises microorganisms any ammonia reducing microorganism. In some embodiments, the at least one microbial species comprises a mixture of different microbial species that reduce ammonia. In some embodiments, the mixture of microbial species includes microorganisms that reduce hydrogen sulfide, odor, methane, and/or noxious materials in the manure and the environment containing the manure.

In some embodiments, the ammonia concentration is less than about 2,500 milligrams per liter (mg/L), less than about 1,000 mg/L, less than about 750 mg/L, less than about 500 mg/L, less than about 250 mg/L, less than about 100 mg/L, less than about 75 mg/L, less than about 50 mg/L, less than about 25 mg/L, less than about 10 mg/L, less than about 5 mg/L, less than about 1 mg/L, or less. In some embodiments, the ammonia concentration is decreased by at least about 5%, at least about 10%, at least about 15%, at least about 20%, at least about 25%, at least about 30%, at least about 40%, at least about 50%, or more as compared to non-treated manure. In some embodiments, the ammonia concentration is decreased from about 5% to about 50%, from about 10% to about 40%, from about 15% to about 30%, from about 20% to about 25% as compared to non-treated manure.

Disclosed herein, in some embodiments, are compositions comprising a quantity of manure and an inert porous medium loaded with at least one microbial species, wherein the quantity of manure has a decreased concentration of noxious materials.

In some embodiments, noxious materials include ammonia, hydrogen sulfide, methane, carbon dioxide, nitrous oxide, odors, toxins, or any combinations thereof. In some embodiments, the compositions are used for treatment of wastewater, manure, and slaughter houses. In some embodiments, compositions comprising manure and an inert porous medium loaded with at least one microbial species have a reduced concentration of noxious gases and odor as compared to manure without the inert porous medium and at least one microbial species.

In some embodiments, the at least one microbial species comprises any noxious material reducing microorganism. In some embodiments, the at least one microbial species comprises a mixture of different microbial species that reduce noxious material. In some embodiments, the mixture of microbial species includes microorganisms that reduce hydrogen sulfide, ammonia, methane, odor, and/or other noxious materials in the manure and the environment containing the manure.

In some embodiments, the noxious material concentration is less than about 10,000 parts per million (ppm), less than about 5,000 ppm, less than about 2,500 ppm, less than about 1,000 ppm, less than about 500 ppm, less than about 100 ppm, less than about 50 ppm, less than about 10 ppm, or less. In some embodiments, the noxious material concentration is decreased by at least about 2.5%, at least about 5%, at least about 10%, at least about 15%, at least about 20%, at least about 30%, at least about 40%, at least about 50%, at least about 75%, or more as compared to non-treated manure. In some embodiments, the noxious material concentration is decreased from about 5% to about 75%, from about 10% to about 75%, from about 15% to about 75%, from about 20% to about 75%, from about 25% to about 75%, for from about 50% to about 75% as compared to non-treated manure.

Disclosed herein, in some embodiments, are methods for decreasing foaming in an environment containing manure comprising: (a) providing a quantity of manure and an inert porous medium loaded with at least one microbial species; and (b) applying an effective amount of the inert porous medium loaded with the at least one microbial species to the quantity of manure, wherein the inert porous medium loaded with the at least one microbial species decreases foaming in an environment containing the quantity of manure.

In some embodiments, application of the inert porous medium loaded with a microbial species decreases foam stability, foam height, or both foam stability and foam height. In some embodiments, foam is stable for less than about 10 minutes, less than about 8 minutes, less than about 6 minutes, less than about 4 minutes, less than about 2 minutes, less than about 1 minute, or less as compared to a non-treated manure. In some embodiments, foam stability is decreased from about 1% to about 50%, from about 5% to about 40%, from about 10% to about 30%, or from about 15% to about 20% as compared to non-treated manure. In some embodiments, the foam height is decreased by at least about 1%, at least about 2%, at least about 5%, at least about 10%, at least about 20%, at least about 30%, at least about 40%, at least about 50%, at least about 60%, or more as compared to non-treated manure.

In some embodiments, the delivered microorganism compositions are applied before, during, or after exposure of an environment to livestock manure. In some embodiments, the delivered microorganism compositions are applied before, during, and after exposure of an environment to livestock manure. In some embodiments, the delivered microorganism compositions are applied at a predetermined time interval. In some embodiments, the delivered microorganism compositions are applied at least once every 0.5, 1, 2, 4, 6, 8, 10, 15, 20, 30, 40, 50, 75, 100, 150, 200, 250, 300, 350, 400, or more days as required to maintain desired microbial activity. In some embodiments, the delivered microorganism compositions are applied at a ratio of at least about 0.02, at least about 0.05, at least about 0.1, at least about 0.2, at least about 0.5, at least about 1, at least about 10, at least about 50, at least about 100, at least about 500, at least about 1000, or more grams of delivered microorganism composition to cubic meter of manure.

In one embodiment, a composition for delivering microorganisms in a dry mode containing precipitated silica granules having a porous structure, and microorganisms loaded throughout the pores of the precipitated silica granules. Exemplary experiments show that the release of H₂S from swine manure that is handled and then subsequently stored without further additions will increase for about three weeks and then decrease to relatively low levels by day 42. Odor release from the manure appears to follow a similar pattern as H₂S. In some embodiments, compositions of delivered microorganisms significantly reduced odor release by 20-60%. In some embodiments, the manure treated with a composition that includes an inert porous medium loaded with at least one microbial species is used as a fertilizer or compose. In some embodiments, delivered microorganism compositions have no observable effect on manure fertilizer value. In some embodiments, the effectiveness of the delivered microorganism composition on H₂S and odor release is not influenced by the dosage level. In an example, the largest reduction in hydrogen sulfide, about 50% relative to the controls after 24 days, was achieved by a medium dose application of the delivered microorganism composition and not by a high dose or a low dose application. The results of this study indicate that ammonia, methane, carbon dioxide and nitrous oxide gas production are not significantly changed by the use of this particular delivered microorganism composition relative to the controls. The olfactometry with a trained sensory panel revealed that the perceived odor contained in these same samples is in line with analytical findings of the reduction of hydrogen sulfide gas. Odor reduction adds credibility to the analytical findings.

### EXAMPLES

### Example 1: Health Study Performed With About 7,000 Head of Swine

Experiments were conducted with about 7,000 pigs placed in barns both treated with the ManureMagic® composition and not treated with the ManureMagic® composition. Gross live weights of the animals were measured in kilograms (kg) at the beginning of the study, as shown below in Table 1.

TABLE 1
Swine count and weight

| | Number of | | |
|---|---|---|---|
| | animals | Gross live | Average weight |
| | placed in the | weight of | of placed |
| Aggregate | bam section | animals, kg | animals, kg |
| Total | 7158 | 225396 | 31.49 |
| Manure | | | |
| Magic ® | | | |
| Total | 7113 | 221018 | 31.07 |
| Control | | | |

The health of the animals in both the treated and non-treated barns was monitored until the animals reached the target sale weight and were ready for sale. The survival rate was measured for both groups, as shown below in Table 2. There was about a statistically significant 1.1% increase in the survival rate, which translated to more than a 100 animals in these experiments.

TABLE 2
Increase in survival rate

| | | | # of full grown | |
|---|---|---|---|---|
| | | | animals | |
| | # of dead | # of sick | available for | Survival |
| Aggregate | animals | animals | sale | rate |
| Total | 196 | 205 | 6757 | 94.4% |
| Manure | | | | |
| Magic ® | | | | |
| Total | 231 | 233 | 6649 | 93.5% |
| Control | | | | |

Gross weights of the animals at the time of the sale were measured in kilograms (kg), as shown below in Table 3. Animals from barns that were treated with the ManureMagic® composition were ready for sale about five days before of the animals from barns that were not treated with the ManureMagic® composition. The animals also gained about 40 grams more per day during the finishing process, thus reaching weights suitable for sale quickly.

TABLE 3
Growth rate and weight

| | | | | Average |
|---|---|---|---|---|
| | | | Average | daily gain |
| | Gross weight | Average | animal age | during |
| | of sold | weight of sold | at time of | finishing, |
| Aggregate | animals, kg | animals, kg | sale, days | in grams |
| Total | 820,140 | 121.38 | 182 | 840.17 |
| ManureMagic ® | | | | |
| Total | 802,936 | 120.76 | 187.33 | 797.66 |
| Control | | | | |

### Example 2: Health Study Performed With About 11,000-14,000 Head of Swine

Another set of experiments were conducted with about 11,000-14,000 pigs placed in barns that were treated with the ManureMagic® composition and that were not treated with the ManureMagic® composition. Gross live weights of the animals were measured in kilograms, as shown below in Table 4. In this cohort population, the observed survival rate was about 0.45%.

TABLE 4
Swine count and weight

| | Number of | | Average |
|---|---|---|---|
| | animals | Gross live | weight of |
| | placed in the | weight of | placed |
| Aggregate | barn section | animals kg | animals, kg |
| Total | 14,271 | 446,314.3 | 31.28 |
| ManureMagic ® | | | |
| Total | 11,594 | 350,525.2 | 30.23 |
| Control | | | |

The health of the animals in both the treated and non-treated barns was monitored until the animals were ready for sale. Gross weights of the animals at the time of the sale were measured in kgs, as shown below in Table 5. Animals from barns that were treated with the ManureMagic® composition were ready for sale about eight days before the animals from barns that were not treated with the ManureMagic® composition. The animals also gained about 4.69 grams more per day during the finishing process, thus reaching weights suitable for sale quickly.

TABLE 5
Growth rate and weight

| | Gross | Average | Average | Average |
|---|---|---|---|---|
| | weight | weight of | animal | daily gain |
| | of sold | sold | age at time | during |
| | animals, | animals, | of sale, | finishing |
| | kg | kg | days | in grams |
| ManureMagic ® | 1,619,014 | 120.85 | 182.4 | 491.11 |
| Control | 1,329,565 | 122.75 | 190.2 | 486.42 |

In other experiments, average daily weight gain increase with ManureMagic® was about 31 g on one farm and 54 g on second farm during the finishing period only, while average daily weight gain increase with ManureMagic® was 13.5 g on one farm and 31.3 g on second farm during the animal lifetime.

The cumulative data from both studies was analyzed. The results of this analysis are shown in Table 6. Pigs in barns treated with the ManureMagic® composition had an increased survival rate of 1.1% compared to animals in the control barns. Considering that the pork price was about $1.36 dollars per pound in the area of study, increased survival rate led to an increase in about $21,000.00 in revenue for the barns treated with ManureMagic® composition, or of about nine million dollars when applied across all the 23 farms of that particular producer with an estimated 9,000,000 head of pigs.

TABLE 6
Study summary

| | ManureMagic ® | Without |
|---|---|---|
| Number of starter pigs | 20,000 | 20,000 |
| Survival % | 94.05% | 93.44% |
| Total to market | 18,810 | 18,688 |
| Total survival weight | 4,977,126 | 4,944,845 |
| Total meat to market | 2,389,020 | 2,373,526 |
| Assumed price per lb | $1.36 | $1.36 |
| Total market value | $3,249,068 | $3,227,995 |
| Value gained using ManureMagic ® | $21,073 | |
| Increase in revenue per starter pig | $1.05 | |

The lower average number of days for the finishing pigs using ManureMagic® composition is indicative of the increase rate of weight gained from the placed date to the sale date. The cumulative average number of days for finishing using the ManureMagic® composition was 183.1. The cumulative average number of days for finishing without the ManureMagic® composition was 188.8. The difference is a total of 5.7 days on average.

### Example 3: Health Study Performed With About 155,000 Head of Swine

Experiments were conducted with about 75,000 to 79,000 pigs placed in barns both non-treated bars and barns treated with the ManureMagic® composition. Starting head count and survival rate is shown in Table 7.

TABLE 7
Study summary

| | ManureMagic ® | Without |
|---|---|---|
| # of head placed | 75,277 | 78,638 |
| # dead, illness head | 5,309 | 5,967 |
| # of head sold | 69,968 | 72,671 |
| Survival % | 92.95% | 92.41% |

The health of the animals in both the treated and non-treated barns was monitored until animals were ready for sale. The survival rate was measured for both groups and was statistically significant for about a 0.6% increase in the survival rate, which translated to more than 400 animal in this experiment.

### Example 4: Hydrogen Sulfide and Odor Reduction Study

The objective of this set of experiments was to evaluate the ManureMagic® composition for efficacy in reducing hydrogen sulfide (H₂S) and odor from swine manure under controlled lab conditions. This test evaluated the effect of three doses of the ManureMagic® composition on gas and odor emissions from stored finisher pig manure. The 42-day laboratory study measured noxious gas release from six (6) simulated pits (reactors) containing swine manure from a local finishing building, which was analyzed prior to adding manure to the reactors and prior to emptying the reactors on the last day of the test. Gas samples taken six times from each reactor were analyzed for hydrogen sulfide, ammonia, methane, nitrous oxide, and carbon dioxide. In addition, a human panel was employed twice—at the midpoint and at the endpoint of the test period—to evaluate odor concentrations in each reactor.

Six manure reactors were set up to mimic the column of air above a deep (8 foot) manure pit under a swine finishing facility. Manure was added to the simulated pits, and for the next 42 days, the headspace of each reactor was purged or ventilated continuously with fresh air that entrained and diluted the gases emitted from the manure in the bottom of the reactor. Reactor exhaust air samples in 50-L bags were taken on days 7, 17, 24, 31, 36 and 41 from each of the six reactors and analyzed for concentrations of ammonia, carbon dioxide, methane, hydrogen sulfide, and nitrous oxide. The measured concentrations were directly proportional to the gas release from the reactors because the volumetric ventilation rate was held constant across reactors and the duration of the test. Reactor exhaust air samples in 10-L bags taken on days 24 and 42 were evaluated with a human panel of trained sniffers. The reactor emission rates for each of the six sampling days were calculated from the ventilation airflow rate and the measurement concentrations. The cumulative masses (in mg or g) of gas emitted from the reactors for the last 30 days of the test were calculated.

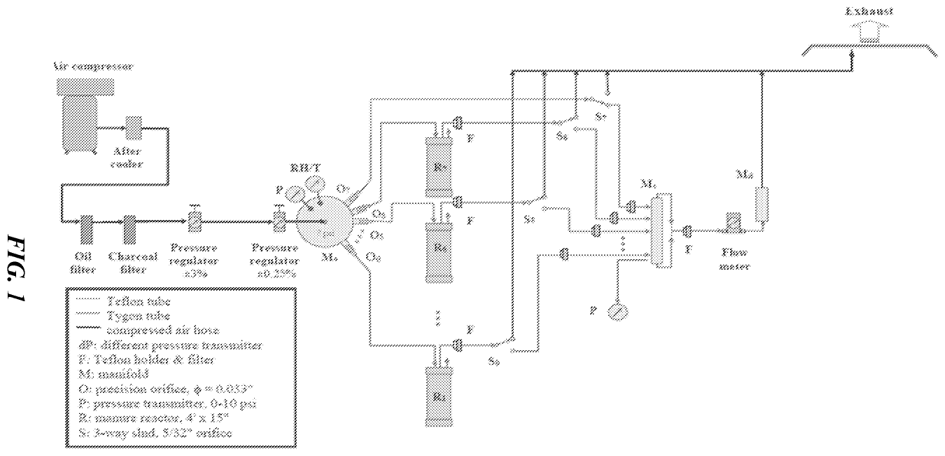

FIG. 1 illustrates the diagram of the test system. An air compressor provided fresh air to the manure reactors. A stainless steel air supply manifold (Mₐ) distributed air equally to all reactors using stainless steel precision orifices. The exhaust air from each reactor flowed through a Teflon tube to a computer controlled 3-way, Teflon-lined solenoid in the gas sampling system, which allowed automatic sequential sampling of the exhaust air of the reactors (6 with manure plus 1 with water). The fresh air from the air supply manifold (Mₐ) was sampled along with the reactor exhausts. Teflon filter holders (with filter-support-meshes but no filters) impeded potential manure flies (none observed in this test). Sampled air flowed to a Teflon gas sampling manifold (Mₛ, FIG. 1), the 0-10 L/min mass flow meter (Model 50S-10, McMillan, Georgetown, Tex.) and the analyzer manifold, M_{d} whereas inactive solenoids directed air to the fume hood. In this way, ventilation air was supplied to each reactor continuously. The air temperature around each reactor was monitored. Two pressure sensors monitored the test system. The first one (WIKA, Tronic Line) measured pressure inside the air distribution manifold. The second one (Setra System, Inc., Boxborough, Mass.) measured the vacuum pressure inside the sampling manifold.

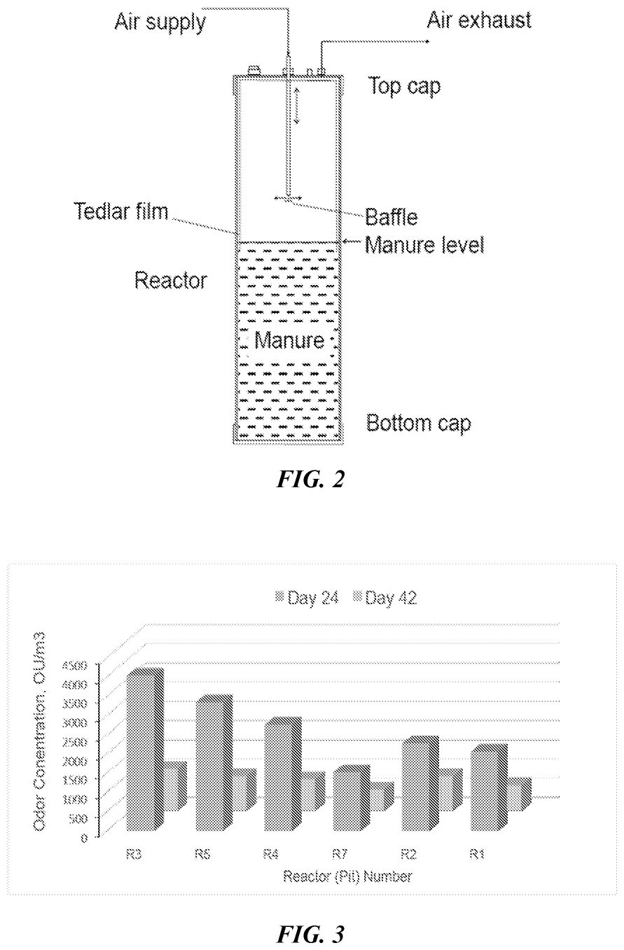

FIG. 2 shows an illustration of an individual manure reactor. There were seven manure reactors used in this experiment. Reactors 1-5 and 7 contained manure and reactor 6 contained tap water. Reactor 6 was used for testing bag sampling methods without disturbing the manure reactors. The reactors were 61 cm (24 in.) tall with an inside diameter of 15 in. (37.9 cm). Each one had a sealed slip cap on the bottom and a removable slip cap on the top. The reactors were lined with 0.05 mm thick Tedlar® film on the top 14 in. (64 cm) of the inside walls. The air inlet opening was adjusted to a height of 6 in. (15 cm) above the manure surface. The air inlet included a baffle to direct air radially in all directions.

On Day 0, about 90 gallons of manure was pumped out of under-floor deep pits of one of the finishing buildings into two 55 gallon barrels and hauled to the experimental site. The manure was thoroughly mixed in the first barrel before randomly adding six inches of manure into each of six reactors. After adding the ManureMagic® composition as prescribed amounts to four of the reactors collecting manure samples from the control reactors (in addition to samples taken from the 55 gallon barrels), the reactors were filled to a depth of 12 inches using well-mixed manure from the second barrel. On day 42, prior to taking manure samples, the depths of the manure in each reactor were measured to determine evaporation loss. Manure samples were submitted to Midwest Labs in Kansas City for analysis.

Based on randomized selection, reactors 3 and 5 were controls and therefore did not have any product added to the manure. A measured 0.1 grams (g) of the ManureMagic® composition was introduced into reactors 4 and 7, and 1 and 2 g were introduced into reactors 2 and 1, respectively. Product inclusions of 0.1, 1 and 2 g are denoted as low, medium and high, respectively. The release of H₂S from swine manure that is handled and then subsequently stored without further additions will increase for about three weeks and then decrease to relatively low levels by day 42. Odor release from the manure appears to follow a similar pattern as H₂S.

The data acquisition and control (DAC) system consisted of a desktop computer, FieldPoint data acquisition and control hardware (National Instruments Co., Austin, Tex.), and DAC software. The DAC program for this test, AirDAC, was written in LabVIEW DAC software (National Instrument, Inc.). AirDAC sampled output signals from the sensors every second. It then calculated the signals, averaged them every minute before saving them in data files. The AirDAC also controlled the solenoids for automatic air sampling. Each reactor was sampled for flow rate, temperature, humidity, and pressure once per cycle for 10 min at a time, and there are four 360-minute cycles per day. Tedlar bags (50-L) were filled with gas from the reactor headspace on days 6, 17, 23, 30, 35 and 40, respectively and taken to the Purdue Swine Environmental Research Laboratory (SERB) for analysis of the gas concentrations in the bags (Table 1). The SERB's gas sampling system pumped air out of the bags at 5 liters per min (L/min) into a Teflon analyzer manifold from which gas analyzers drew continuous subsamples.

Hydrogen sulfide was measured with a 0-10,000 ppb pulsed fluorescence SO2 analyzer (Model 340, TEI, Inc., Mansfield, Mass.). Carbon dioxide, ammonia, and methane measured with a photoacoustic infrared multigas analyzer (INNOVA 1412, LumaSense Technologies, Copenhagen, Denmark) and a gas filter correlation analyzer (Teledyne Model 320EU) was used to measure nitrous oxide. The gas analyzers at SERB were calibrated weekly using certified gases in cylinders. The cylinder gases were diluted to desired concentrations using a gas dilution system (Environics 4040, Environics, Toland, Conn.). These instruments and calibration method were also used in the National Air Emissions Monitoring Study.

On days 24 and 42, odor samples were collected into two 10-L Tedlar bags from each reactor. Each bag was filled directly from the headspace to minimize losses and absorption to tubing. Positive pressure within each reactor forced the headspace air into the bags over a period of 75 min. The air from the air distribution manifold was also sampled. All sample bags were preconditioned in a similar manner. Each bag was filled twice to ⅓ it's fullness with nitrogen gas and emptied using a vacuum pump. The evaluations of all odor samples were conducted within 30 h of collection to minimize storage losses. Odor samples taken from the laboratory test were evaluated at the Purdue Agricultural Air Quality Lab using an odor panel and a dynamic olfactometer. Lim et al. (2003) described the detailed standardized procedure of odor evaluation.

The strength or concentration of an odor is measured by determining the dilution factor required to reach the odor detection threshold (ODT). As odor strength increases, ODT also increases because more odor-free air is needed to dilute the sample to its ODT. The ODTs were measured with a dynamic dilution forced-choice olfactometer (a dilution apparatus). This olfactometer (ACSCENT International Olfactometer, St. Croix Sensory, Stillwater, Minn.) met the olfactometry standards of the United States (ASTM, 1992) and Europe (ECN, 2000). The odor panel consisted of four trained human subjects that were screened to determine their odor sensing ability (ASTM, 1981). The odor panel was managed in accordance with ASTM STP 758, Guidelines for the Selection and Training of Sensory Panel Members (ASTM, 1981) and ANSI/ASQC Q2-1991, Quality Management and Quality System Elements for Laboratories (ANSI, 1991). All panel members were non-smokers. The olfactometer delivered a precise mixture of sample and dilution air to the panelist through a Teflon-coated presentation mask at 20 liters per minute (lpm). The dilution ratio of the mixture is the ratio of total diluted sample volumetric flow rate to the volumetric flow rate of the sample. For example, a dilution ratio of 1000 is achieved with 20 milliliters per minute (mL/min) of sample flow and 20 liters per minute (L/min) of total diluted flow.

The olfactometer diluted the odor sample starting with a high dilution ratio, and presented a step by step series of ascending concentrations (step factor=2) to each panelist. A triangle test was conducted whereby the panelist sniffed all three sequential sample coded gas streams at each dilution ratio. One gas stream was randomly assigned to have the odor while the other two gas streams were odor-free. The three gas streams were directed one at a time to the mask. The panelist selected which of the three presentations was “different” (even if no difference was perceived) and thus contained the odor (ASTM, 1992). The panelist declared by pressing a button whether the selection was a “guess” (no perceived difference), “detection” (selection is different from the other two), or “recognition” (selection smells like something). The sample at the initial dilution steps are so dilute that they cannot be distinguished from odor-free air. Higher and higher odor concentrations (2-fold increases), or lower and lower sample dilutions (50% reductions), were presented to each panelist until the sample was correctly detected and/or recognized in two consecutive steps. An individual best-estimate ODT estimate was calculated by taking the geometric mean of the last non-detectable dilution ratio and the first detectable dilution ratio. The panel ODT was calculated as the geometric mean of the individual ODTs. Retrospective screening of each panelist threshold was applied to the panel ODT (ECN, 2000). To assess panelist performance, a reference odorant n-butanol (40 ppm) was included in each odor session and was evaluated like the other samples. The n-butanol evaluations were used to document olfactometer and panelist performance (ECN, 2000) by calculating the odor detection concentration (ODC) for the n-butanol and comparing it to the target value of 40 ppb (ECN, 2000). The odor concentration in terms of European odor units (OUE) was calculated by multiplying the ODT by the ratio of the n-butanol ODC by 40 ppb. The evaluation of effects on odor was based on the difference between exhaust air odor concentration and the odor concentration in the air supply, or the net odor concentration.

The analysis results of the source manure at the initial reactor filling are shown in Table 8. The samples showed reasonably good uniformity among samples indicated by the low relative standard deviations, which ranged from 0.6% for pH to 55% for organic nitrogen and averaged 18.4%.

TABLE 8
Characteristics of source manure on the first day, mg/L

| Sample | R1 | R2 | R3 | R4 | R5 | R7 | Mean±SD |
|---|---|---|---|---|---|---|---|
| Ammonia | 0.22 | 0.28 | 0.27 | 0.27 | 0.28 | 0.28 | 0.27 ± 0.03 |
| nitrogen (total) | | | | | | | |
| Organic nitrogen | 0.14 | 0.16 | 0.12 | 0.12 | 0.35 | 0.12 | 0.17 ± 0.10 |
| TKN | 0.36 | 0.44 | 0.39 | 0.39 | 0.63 | 0.40 | 0.44 ± 0.11 |
| Phosphorus | 0.21 | 0.23 | 0.16 | 0.18 | 0.21 | 0.18 | 0.20 ± 0.03 |
| Potassium | 0.16 | 0.19 | 0.19 | 0.20 | 0.19 | 0.25 | 0.20 ± 0.02 |
| Total solids | 4.6 | 5.6 | 3.6 | 3.6 | 4.4 | 3.6 | 4.3 ± 0.8 |
| pH | 7.00 | 7.00 | 7.00 | 7.00 | 7.10 | 7.70 | 7.1 ± 0.05 |
| Sulfur (total) % | 0.03 | 0.03 | 0.02 | 0.03 | 0.03 | 0.02 | 0.03 ± 0.04 |

The samples taken from the reactors on day 42 exhibited relative uniformity as the relative standard deviations ranged from 0.8 for pH to 19.4% for total sulfur (Table 8). The ManureMagic® composition therefore had no apparent effect on the fertilizer value of the manure nor any other analyzed characteristic (Table 9). However, the analysis of solids in reactor 4 (R4) was significantly higher (P<0.05) at 5.0% as compared with the overall average of 3.9%. This reactor could potentially be considered an outlier and its data removed from the analysis. The manure depths on day 42 were 10.0, 9.8, 10.5, 9.8, 10.0 and 10.5 inches in reactors 1-5 and 7, respectively. The water loss ranged from 12.5 to 18.8% and averaged 15.8%, which was an average depth reduction of 1.2 mm per day. The average daily mean temperature of the reactor room during the test was 23±1° C. The overall average hourly mean reactor ventilation rate was 7.25±0.10 L/min.

TABLE 9
Characteristics of source manure on the last day, mg/L

| | | | | DryLet M2^{®} | | | | |
|---|---|---|---|---|---|---|---|---|
| Parameter | Controls | | | Low | | Med | High | Treated |
| | R3 | R5 | Avg | R4 | R7 | R2 | R1 | Avg |
| Ammonia | 0.28 | 0.28 | 0.28 | 0.29 | 0.28 | 0.28 | 0.28 | 0.28 |
| nitrogen | | | | | | | | |
| (total) | | | | | | | | |
| Organic | 0.12 | 0.14 | 0.13 | 0.16 | 0.12 | 0.14 | 0.13 | 0.14 |
| Nitrogen | | | | | | | | |
| TKN | 0.40 | 0.42 | 0.41 | 0.45 | 0.40 | 0.42 | 0.41 | 0.42 |
| Phosphorus | 0.18 | 0.21 | 0.195 | 0.23 | 0.18 | 0.21 | 0.18 | 0.20 |
| Potassium | 0.26 | 0.26 | 0.26 | 0.26 | 0.25 | 0.25 | 0.26 | 0.25 |
| Total solids | 3.5 | 4.0 | 3.75 | 5.0 | 3.6 | 4.1 | 3.5 | 4.1 |
| pH | 7.6 | 7.6 | 7.6 | 7.5 | 7.7 | 7.6 | 7.6 | 7.6 |
| Sulfur | 0.02 | 0.03 | 0.025 | 0.03 | 0.02 | 0.03 | 0.03 | 0.03 |
| (total) % | | | | | | | | |

The panel average n-butanol concentrations were 54.7 and 13.8 ppb for the two odor sessions and days 24 and 42, respectively. From these data, the European odor units were calculated. The average net concentrations for two samples per reactor are shown in Table 4. The odor concentrations of the air supply were 301 and 96 OUE/m³ on days 24 and 42, respectively.

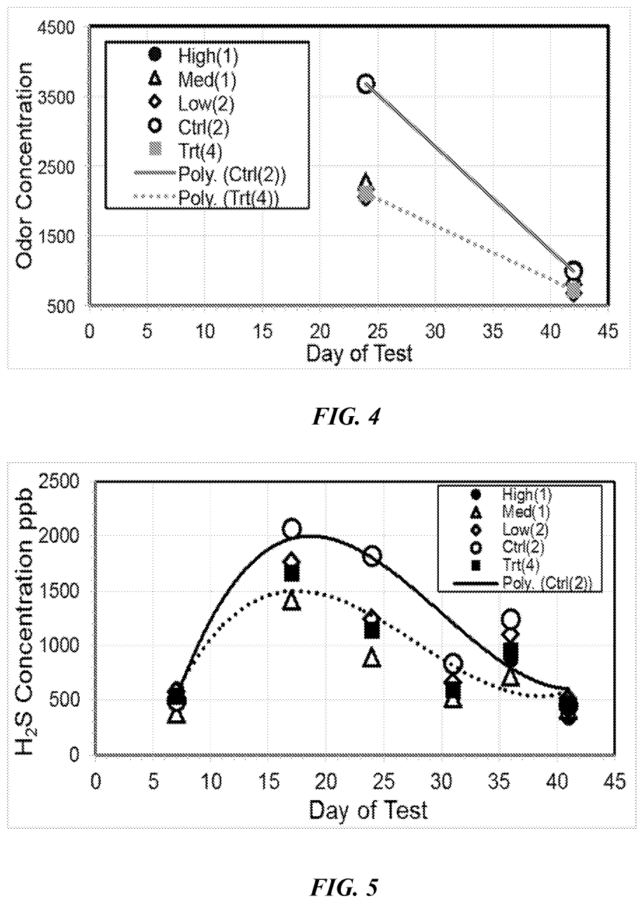

FIG. 3 shows the average odor concentration for reactors on days 24 and days 42. FIG. 4 shows the odor shows the odor concentrations for the treated and non-treated reactors on days 24 and 42. Assuming odor concentration is correlated with H₂S concentrations, it is expected that the maximum odor concentrations will occur in the third week and gradually decrease until the end of the test. This is confirmed by the differences in odor concentrations of all reactors between days 24 and 42 (Table 10 and FIG. 3). The average decrease in reactor headspace odor concentration from days 24 to 42 ranged from 60 to 73% and averaged 68%. As the emissions subsided as fresh manure was not added after the initial fill (FIG. 4)

TABLE 10
Net odor concentrations of the reactor headspaces (n = 2), OU_{E}/m³

| Day | R3 | R5 | R4 | R7 | R2 | R1 | Ctrl | Low | Med | High | Trt |
|---|---|---|---|---|---|---|---|---|---|---|---|
| 24 | 4038 | 3338 | 2760 | 1520 | 2273 | 2060 | 3672 | 2049 | 2273 | 2060 | 2106 |
| 42 | 1094 | 903 | 819 | 550 | 903 | 672 | 994 | 671 | 903 | 672 | 723 |

The H₂S concentrations of each bag sample along with averages of control and treatment reactors are given in Table 11. As observed in previous studies of stored manure, the release of H₂S from all reactors increased to a maximum on day 17 and decreased gradually to the end of the test. The concentrations were similarly low on the first and last sampling events on days 7 and 41, respectively. The explanation for the low initial values on day 7 is that the original H₂S was released from the manure during the pumping, transport and delivery to the reactors and it requires several days for the microbial population to become established once again in the manure. The explanation for the releases to return to day 7 levels on day 41 is that since no new manure was added to the reactors after the first day, the microbial nutrients became depleted. Thus, the focus for evaluating the efficacy of the product in reducing H₂S was the middle four sampling days (days 17, 24, 31 and 36). FIG. 5 shows the H₂S concentration for treated and non-treated reactors. A clear trend of lower mean H₂S concentrations in the treated reactors as compared with the control reactors is observed. The overall group-mean H₂S concentrations for days 17-36 were 1489 ppb for the control reactors and 1189, 885 and 1078 ppb (20, 41 and 28% lower than the controls) for the low, medium and high dosages of the ManureMagic® composition.

The average H₂S concentrations of the treated reactors were 20, 37, 29 and 24% lower than the average of the control reactors on days 17, 24, 31 and 26, respectively. The overall average H₂S concentration of all four treated reactors on the middle four sampling days was 1085 ppb which is 27% less than the 1489 ppb average concentration in the control reactors on the same days. If the high solids reactor R4 is removed from the analysis, the reduction is 34%.

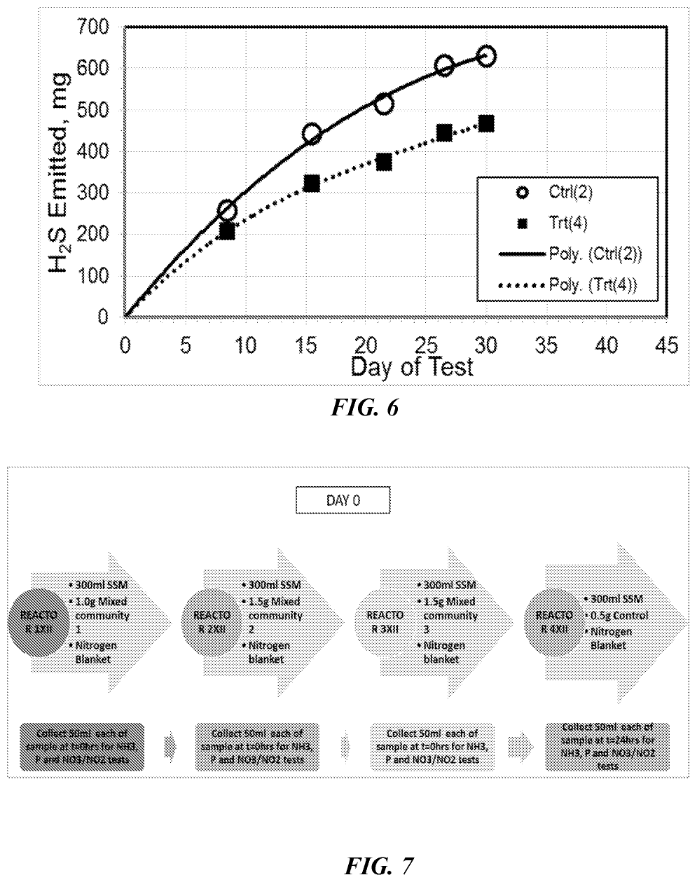

FIG. 6 shows the average cumulative release of H₂S over 30 days. The average cumulative release of H₂S reached 630 and 467 mg for the control and treated reactors, a 26% difference. The results strongly suggest that the ManureMagic® composition reduces H₂S released from swine manure pits around 30% and at the same time reduces odor by around 30%. The dose of the ManureMagic® composition used seemed to have little impact on H₂S/odor reduction. Reactor R4 may have underperformed simply due to the difficulties associated with the delivery of tiny amounts of the solid particles and because the solids content were unusually high as compared with the other reactors. Still, the average values for H₂S concentration amongst all treated reactors was about 27% reduction, without regard to the dose applied. The ManureMagic® composition best performance was obtained with a medium dosage of 1 g, achieving a reduction of H₂S relative to the controls of about 51% after 24 days.

TABLE 11
Hydrogen sulfide concentrations in pit headspace, parts per billion (ppb)

| | | | DryLet | | DryLet M2^{®} | DryLet | | | | | |
|---|---|---|---|---|---|---|---|---|---|---|---|
| | Controls | | M2^{®} Low | | Medium | M2^{®} High | Averages | | | | |
| Day | R3 | R5 | R4 | R7 | R2 | R1 | Controls | Low | Med | High | Treated |
| 7 | 645 | 337 | 684 | 472 | 381 | 603 | 491 | 578 | 381 | 603 | 535 |
| 17 | 2445 | 1686 | 1798 | 1722 | 1411 | 1719 | 2066 | 1760 | 1411 | 1719 | 1663 |
| 24 | 1818 | — | 1621 | 853 | 895 | 1178 | 1818 | 1237 | 895 | 1178 | 1137 |
| 31 | 877 | 784 | 907 | 413 | 516 | 536 | 831 | 660 | 516 | 536 | 593 |
| 36 | 1359 | 1122 | 1171 | 1028 | 720 | 878 | 1241 | 1099 | 720 | 878 | 949 |
| 41 | 491 | 419 | 689 | 328 | 410 | 342 | 455 | 508 | 410 | 342 | 442 |

The average gas concentrations for the various reactor groupings were calculated for ammonia, methane, nitrous oxide, and carbon dioxide. The treatment had no apparent effect on these gases, as expected, but the data proves that the random order in which the reactors were filled was effective in establishing similar manure characteristics among the reactors.

The overall average ammonia concentration of all four treated reactors on the middle four sampling days was 56 ppm as compared with 58 ppm for the control reactors. The average mass of ammonia released was 12.2 and 12.6 g for the treated and control reactors, respectively. The change in ammonia concentration production is about 3% and may not be significant.

The overall average methane concentration of all four treated reactors on the middle four sampling days was 411 ppm as compared with 409 ppm for the control reactors. The average mass of methane released was 85 and 83 g for the treated and control reactors, respectively.

The overall average nitrous oxide concentration of all four treated reactors on the middle four sampling days was 342 as compared with 340 ppb for the control reactors. The average mass of nitrous oxide released was 25 and 24 mg (assume 300 ppb ambient concentration) from the treated and control reactors, respectively.

The overall average carbon dioxide concentration of all four treated reactors on the middle four sampling days was 953 as compared with 957 ppm for the control reactors. The average mass of total carbon dioxide released was 535 and 529 g (assuming 380 ppm as the ambient concentration) from the treated and control reactors, respectively.

The results strongly suggest that the ManureMagic® composition reduces H₂S released from swine manure pits around 30% and at the same time reduces odor by around 30%.

The dose of the ManureMagic® composition used seemed to have little impact on H₂S/odor reduction. Reactor R4 may have underperformed simply due to the difficulties associated with the delivery of tiny amounts of the solid particles and because the solids content were unusually high as compared with the other reactors. Still, the average values for H₂S concentration amongst all treated reactors was about 27% reduction, without regard to the dose applied.

The olfactometry with a trained sensory panel revealed that this estimate is in line with the perceived odor contained in these same samples.

The ManureMagic® composition significantly (P<0.05) reduced odor release by 43% on day 24 of the test and (P>0.05) reduced odor release by 27% on day 42. The ManureMagic® composition reduced the release of H₂S by 27% based on the collective samples taken from all treated reactors on days 17, 24, 31 and 36. The ManureMagic® composition had no observable effect on manure fertilizer value. The effectiveness of the ManureMagic® composition on H₂S and odor release was not significantly influenced by the dosage level. The ManureMagic® composition performed best with medium dose, achieving a reduction of H₂S relative to the controls of about 50% after 24 days. The results of this study indicate that ammonia, methane, carbon dioxide and nitrous oxide gas production are not significantly changed by the use of the ManureMagic® composition relative to the controls. The olfactometry with a trained sensory panel revealed that the perceived odor contained in these same samples is in line with analytical findings of the reduction of hydrogen sulfide gas. Odor reduction adds credibility to the analytical findings.

### Example 5: Ammonia Reduction Study

The objective of this study was to evaluate the efficacy of ManureMagic® combined with nitrifying organisms and/or ammonia oxidizing bacteria in reducing ammonia concentration from synthetic swine manure in controlled laboratory conditions. Ammonia concentration was evaluated following EPA method 350.1 (Environmental Protection Agency (1993). Method 350.1: determination of ammonia nitrogen by Semi-Automated Colorimetry). The composition of synthetic swine manure is shown in Table 12. The synthetic swine manure was treated with a commercially available microbial culture in liquid form and the ManureMagic® composition combined with various mixed communities of nitrogen fixing bacteria loaded onto an inert porous medium. Eight total reactors were used for this experiment. Two reactors were treated with the commercially available microbial culture and six reactors were treated with the ManureMagic® composition combined with one of three different cultures of a mixed microbial community. Each of the different cultures of the mixed microbial community (mixed community 1-3) contained different species and/or amounts of nitrifying and ammonia oxidizing bacteria.

Eight reactor bottles of 1 L capacity were set up and filled with 300 ml of Synthetic Swine Manure (SSM) and varying components of the treatment compositions. The reactors were further purged with nitrogen gas to replicate the natural anaerobic condition in swine pits. The SSM was prepared in the lab based on nutrient analysis of actual liquid swine manure. The composition of the SSM is provided in Table 12. The manure was added to the reactors and the study was performed over a period of 144 hours, i.e., 7 days. Over the 7 day period, the reactors were replenished with swine manure, a minimal volume of the treatment compositions, and nitrogen blanketed to maintain anaerobic growth condition.

TABLE 12
Swine manure composition and ratio

| Chemicals to be added | | | Elements Captured, in % | | | | |
|---|---|---|---|---|---|---|---|
| in a 1L solution, in mgs | | in gms | N | P | K | C | S |
| NaH₂PO₄ | 0 | 0.0 | | 25.8 | | | |
| KNO₃ | 0 | 0.0 | 13.9 | | 38.6 | | |
| KH₂PO₄ | 3610 | 3.6 | | 22.8 | 28.7 | | |
| (NH₄)₂SO₄ | 900 | 0.9 | 21.2 | | | | 24.2 |
| Aspartic Acid | 3325.0 | 3.3 | 10.5 | | | 36.1 | |
| MgSO₄ | 0.0 | 0.0 | | | | | 26.7 |
| MnSO₄ | 0.0 | 0.0 | | | | | 21.2 |
| Dextrose | 6000 | 6.0 | | | | 40.0 | |
| Maltose | 6000 | 6.0 | | | | 40.0 | |
| Ammonium | 3000 | 3.0 | 18.2 | | | 31.2 | |
| acetate | | | | | | | |

Samples were removed at an interval of 24 hours, to check for traces of ammonia, nitrate, and nitrite in the swine manure. Basic analysis of ammonia reduction was based on La Motte's Ammonia Nitrogen Color test on the range of 0-8.0 PPM. Real time analysis was based on EPA's standard method of ammonia, nitrite and nitrate detection using Method 350.1 and Method 300.0 respectively. Ammonia concentration in the swine manure was observed and tested over the week and the reduction percentage was calculated on the basis of the data received.

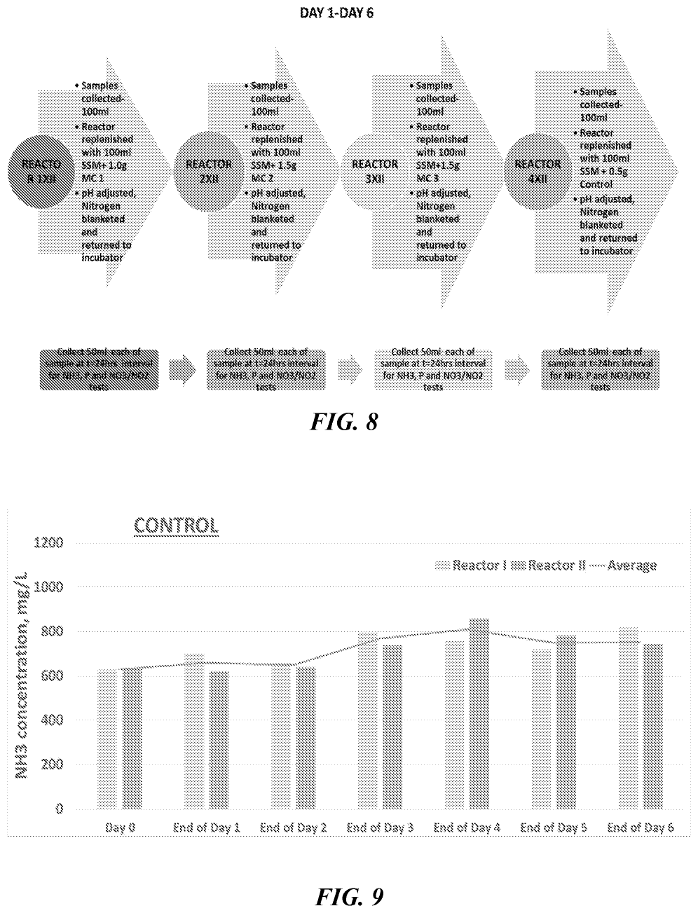

FIG. 7 schematically illustrates the experimental set-up on day zero. FIG. 8 schematically illustrates the experimental set-up on days 1 through 6. Each reactor bottle contained an initial volume of 300 mL of swine manure. Reactor I and its replicate Reactor II contained 0.5 g of ManureMagic® and 0.5 g of mixed community 1. Reactor III and its replicate Reactor IV contained 0.5 g of ManureMagic® and 1 g mixed community 2. Reactor V and its replicate contained 0.5 g of ManureMagic® and 1 g of mixed community 3. Reactors VII and VIII contained 0.5 g of a commercially available microbial culture. Each reactor was purged and Nitrogen blanketed to achieve the anaerobic condition observed in Swine manure pits.

Samples were collected from each reactor from Day 1 through Day 6, and the reactors were replenished with 100 mL of the synthetic swine manure and 1/10th (0.05 g) the initial concentration of the treatment compositions each day. The reactors were maintained at a temperature of 37° C. and an anaerobic environment was maintained with nitrogen purging.

The experiments were left undisturbed for a 24 hour cycle. Reactors were removed from the incubator for sampling and nutrient replenishment once every 24 hours. For effective and consistent results, the sampling was carried out at carefully monitored conditions in the laboratory. The pH of Synthetic Swine Manure (SSM) was adjusted to 7.1 with 1 M NaOH. The sample of SSM was collected for the initial Ammonia (NH₃) and Nitrate/Nitrite (NO₃)/(NO₂), and Phosphate (P) reading by the EPA accepted method. Initial in-lab analysis for Ammonia was carried out using La Motte's Ammonium Nitrogen and Nitrate Test Kit. The reactors were purged with Nitrogen gas for 15 minutes and again blanketed for 15 minutes to attain the anaerobic condition in swine pits. The reactors were sealed tightly and placed in the incubator overnight, at 37° C. At t=24 hours, the initial gas reading, pH, and dissolved oxygen (DO) of the reactors were taken, along with the in-lab ammonia detection color test. Samples were collected for the detailed analysis of ammonia, nitrate and nitrite concentration. After samples were taken, 100 mL of fresh synthetic swine manure was added to the reactor bottles, along with 0.05 g of the respective treatment composition in corresponding reactors. The pH was adjusted to 7.1 using 1 M sodium hydroxide (NaOH) and purged with nitrogen to return to anaerobic conditions and returned to the incubator. The process is repeated at an interval of 24 hours for the seven days total. After the final set of samples were collected from the reactors on the seventh day, the reactors were bleached and discarded.

FIG. 9 shows the ammonia concentration for the two control reactors as a function of day. During the first two days of the study, the concentration of ammonia remains constant. After day two, a trend of increasing ammonia concentration is seen. Initial measurements and measurements taken during day one through day six are shown in Table 13. Negligible ammonia reduction is observed from day zero to day six with a slight increase from the initial to the final measurements.

TABLE 13
Measurements taken day zero through day six for control samples.
CONTROL

| | Initial_NH3, | Change in NH3 | Daily_NH3_%_ | Daily_%_pH | Alkalinity added | NaOH required | Gas produced, | NH3 consumed, |
|---|---|---|---|---|---|---|---|---|
| | mg/l | conc, mg/l | reduction, % | Drop | as NaOH, ml | per pH % change | in. water | in gms |
| Day 0 | 630.00 | | | | | | | |
| Day 1 | 650.00 | 30.00 | −4.76 | 13.24 | 5.00 | — | 0.00 | −9.00 |
| Day 2 | 643.33 | 0.00 | 0.11 | 10.08 | 3.25 | 0.32 | 50.00 | 8.00 |
| Day 3 | 723.33 | −126.67 | −19.65 | 6.01 | 3.00 | 0.50 | 50.00 | −38.00 |
| Day 4 | 750.00 | −86.67 | −12.26 | 6.69 | 3.00 | 8.45 | 50.00 | −26.00 |
| Day 5 | 715.57 | −10.00 | −1.30 | 5.94 | 3.20 | 0.54 | 50.00 | −3.00 |
| Day 6 | 730.00 | −63.33 | −9.20 | 6.00 | 3.00 | 0.50 | 50.00 | −19.00 |

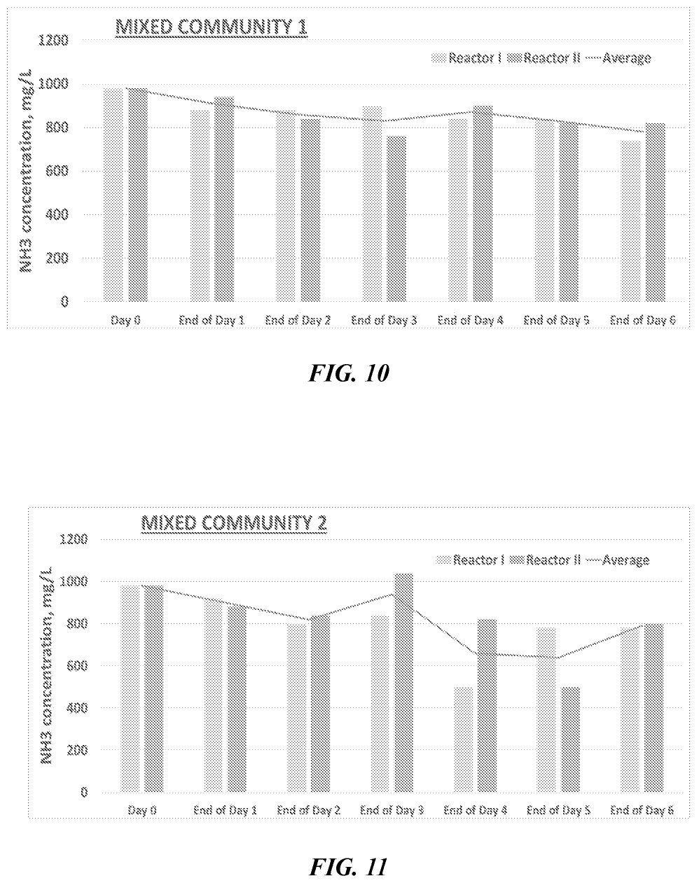

FIG. 10 shows the ammonia concentration for the two reactors containing Manure Magic® and mixed community 1 loaded on an inert porous medium. During the course of the trial the concentration of ammonia concentration appears to decrease with a slight increase on day four and then subsequent decrease on day five and day six. Initial measurements and final measurements taken day one through six are shown in Table 14.

TABLE 14
Measurements taken day zero through day 4 for samples containing ManureMagic® and mixed community 1.
MIXED COMMUNITY 1

| | Initital_NH3, | Change in NH3 | Daily_NH3_%_ | Daily_%_pH | Alkalinity added | NaOH required | Gas produced, | NH3 consumed, |
|---|---|---|---|---|---|---|---|---|
| | mg/l | conc, mg/l | reduction, % | Drop | as NaOH, ml | per pH % change | in. water | in gms |
| Day 0 | 980.00 | | | | | | | |
| Day 1 | 816.67 | 70.00 | 7.14 | 11.76 | 5.00 | — | 0 | 21 |
| Day 2 | 783.33 | −43.33 | −5.43 | 15.69 | 3.50 | 0.22 | 50 | −13 |
| Day 3 | 763.33 | −46.67 | −5.84 | 6.61 | 3.75 | 0.57 | 50 | −14 |
| Day 4 | 790.00 | −106.67 | −14.64 | 7.59 | 3.50 | 0.46 | 50 | −32 |
| Day 5 | 763.33 | −40.00 | −5.16 | 8.55 | 3.00 | 0.35 | 50.00 | −12.00 |
| Day 6 | 846.67 | −16.67 | −2.26 | 11.70 | 3.10 | 0.26 | 50.00 | −5.00 |

FIG. 11 shows the ammonia concentration for the two reactors containing ManureMagic® and mixed community 2 loaded on an inert porous medium. During the course of the trial the concentration of ammonia concentration was observed to decreases. There was a steady decrease in ammonia concentration observed on days one and two and an increase in concentration seen on day three. On days four through six the ammonia concentration fluctuated with an overall decreasing trend. Initial measurements and measurements taken day one through four are shown in Table 15.

TABLE 15
Measurements taken day zero through day 4 for samples containing ManureMagic® and mixed community 2.
MIXED COMMUNITY 2

| | Initital_NH3, | Change in NH3 | Daily_NH3_%_ | Daily_%_pH | Alkalinity added | NaOH required | Gas produced, | NH3 consumed, |
|---|---|---|---|---|---|---|---|---|
| | mg/l | conc, mg/l | reduction, % | Drop | as NaOH, ml | per pH % change | in. water | in gms |
| Day 0 | 980.00 | | | | | | | |
| Day 1 | 810.00 | 80.00 | 8.16 | 14.44 | 5.00 | — | 0.00 | 24.00 |
| Day 2 | 756.57 | −10.00 | −1.30 | 15.02 | 3.75 | 0.25 | 100.00 | −3.00 |
| Day 3 | 836.67 | −183.33 | −24.03 | 10.67 | 2.75 | 0.25 | 100.00 | −55.00 |
| Day 4 | 850.00 | 176.67 | 22.15 | 6.15 | 4.25 | 0.69 | 100.00 | 53.00 |
| Day 5 | 836.67 | 10.00 | −4.82 | 7.61 | 3.50 | 0.46 | 100.00 | 3.00 |
| Day 6 | 736.67 | −153.33 | −27.04 | 5.60 | 3.50 | 0.62 | 100.00 | −46.00 |

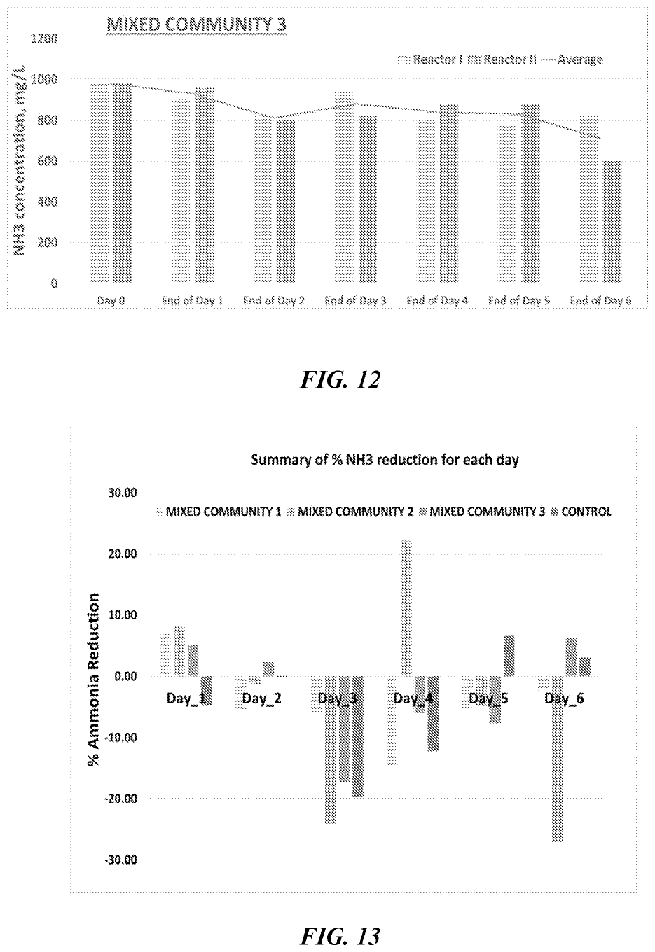

FIG. 12 shows the ammonia concentration for the two reactors containing ManureMagic® and mixed community 3. During the course of the trial, the total ammonia concentration was observed to decrease. There was a steady decrease in ammonia observed on days one and two. On day three, there was an increase in the concentration of ammonia followed by a downward trend for the remaining days of the trail. Initial measurements and final measurements taken day one through day six are shown in Table 16.

TABLE 16
Measurements taken day zero through day 6 for samples containing ManureMagic® and mixed community 3.
MIXED COMMUNITY 3

| | Initital_NH3, | Change in NH3 | Daily_NH3_%_ | Daily_%_pH | Alkalinity added | NaOH required | Gas produced, | NH3 consumed, |
|---|---|---|---|---|---|---|---|---|
| | mg/l | conc, mg/l | reduction, % | Drop | as NaOH, ml | per pH % change | in. water | in gms |
| Day 0 | 980.00 | | | | | | | |
| Day 1 | 830.00 | 50.00 | 5.10 | 13.10 | 5.00 | — | 50.00 | 15.00 |
| Day 2 | 750.00 | 20.00 | 2.32 | 16.91 | 3.25 | 0.19 | 50.00 | 6.00 |
| Day 3 | 796.67 | −130.00 | −17.27 | 11.17 | 4.50 | 0.40 | 50.00 | −39.00 |
| Day 4 | 770.00 | −83.33 | −5.96 | 9.30 | 3.50 | 0.38 | 50.00 | −13.00 |
| Day 5 | 763.33 | −60.00 | −7.70 | 7.16 | 3.00 | 0.42 | 50.00 | −18.00 |
| Day 6 | 800.00 | 53.33 | 6.18 | 7.90 | 3.00 | 0.38 | 50.00 | 16.00 |

FIG. 13 shows the percent ammonia removal efficiency for all treatment types after four days. It was observed that the control reactors had the lowest percentage removal of ammonia at 1.29%. The reactors treated with ManureMagic® and mixed community 1 and ManureMagic® and mixed community 3 had the next lowest percentage removal of ammonia at 5.67% and 4.78% respectively. The reactors treated with ManureMagic® and mixed community 2 had the highest percentage removal of ammonia at 23.07%. The ammonia mass balance for all reactors is shown in Table 17.

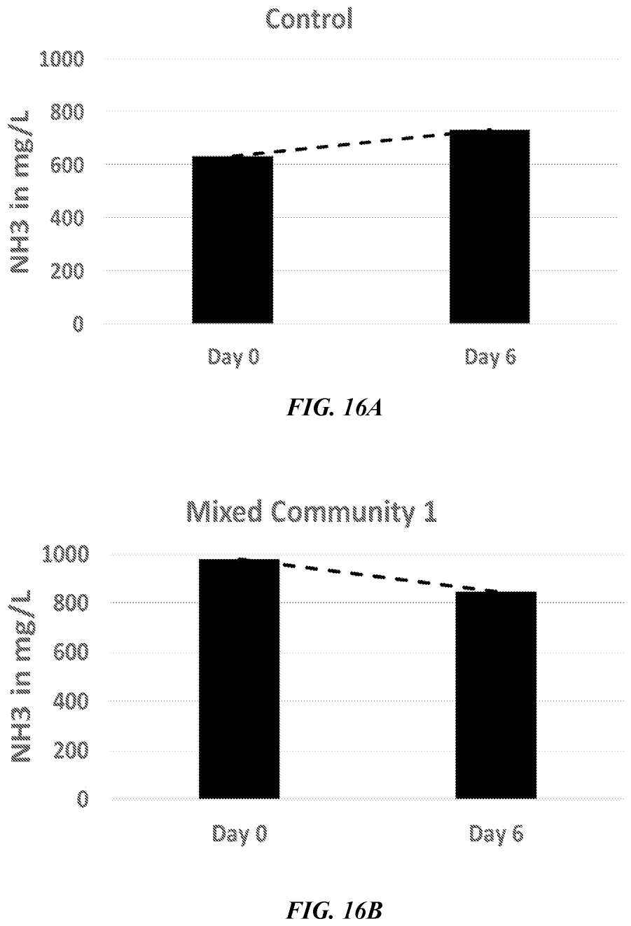

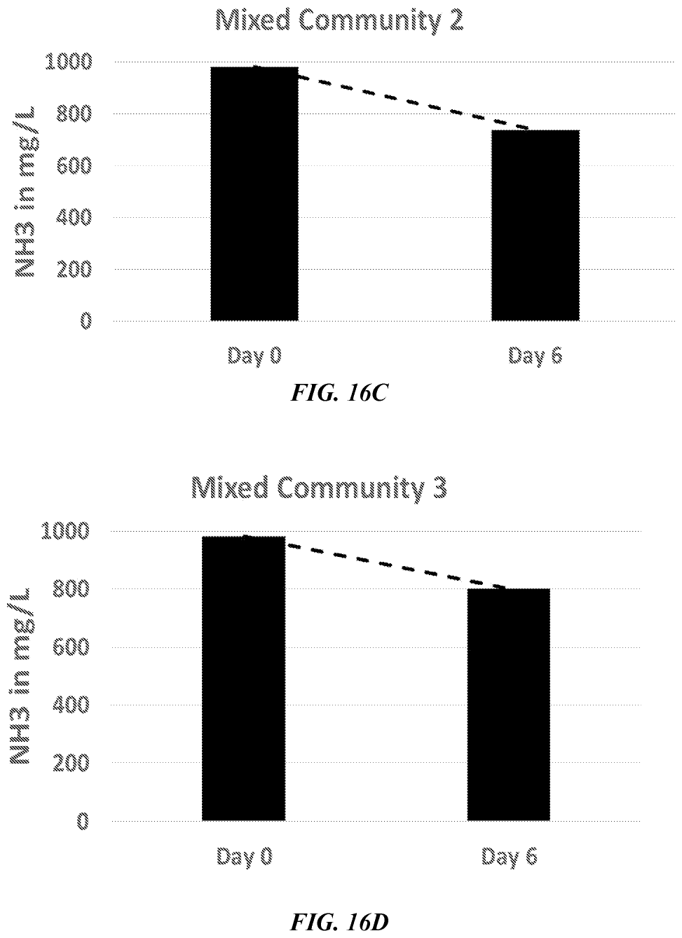

FIGS. 16A, 16B, 16C, and 16D show the increase or decrease in ammonia concentration for control, mixed community 1, mixed community 2, and mixed community 3, respectively.

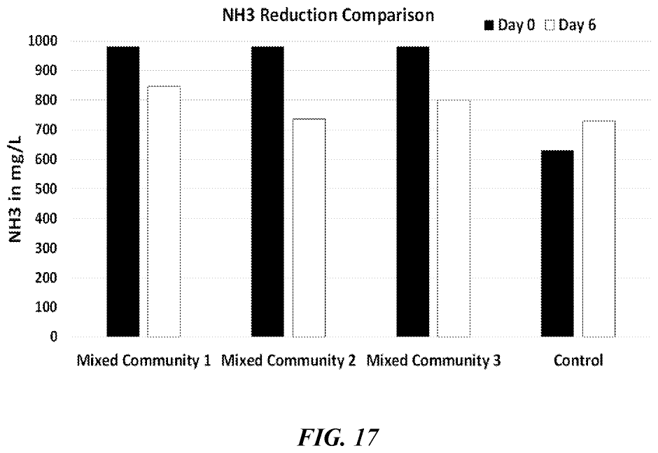

FIG. 17 shows the total percent reduction over the six-day period of 13.6%, 24.8%, and 18.3% for mixed community 1, mixed community 2, and mixed community 3, respectively. The control showed an increase of 15.8% ammonia.

TABLE 17
Mass balance on all reactors observed over six days.

| | | NH3 | | NH3 | Overall |
|---|---|---|---|---|---|
| | | removed | NH3 | consumed | NH3 |
| | NH3 | for | left in | in | removal |
| | added, | sampling, | reactor, | reaction, | efficiency, |
| | in mgs | mgs | mgs | mgs | % |
| MIXED | 966 | 694 | 522 | 45 | 5.67 |
| COMMUNITY 1 | | | | | |
| MIXED | 966 | 664 | 396 | 161 | 23.07 |
| COMMUNITY 2 | | | | | |
| MIXED | 966 | 612 | 504 | 41 | 4.78 |
| COMMUNITY 3 | | | | | |
| CONTROL | 504 | 272 | 390 | 8 | 1.29 |

### Example 6: Field Evaluation and Foam Mitigation

This study was performed in a deep pit swine barn in northeast Iowa. The deep pit swine finishing facility had two pumps on each end of the four pits with five tunnel fans on the west side. The facility used for this study had a history of foaming. At the beginning of the study there was no foam in the facility. Samples were taken from the facility approximately once every two weeks over a one year period.

The foaming capacity and stability apparatus used in this study, as well as the parameters used to evaluate the foaming characteristics of swine manure, were adapted from several other studies. Air was passed through an in-line gas regulator (Restek Model 21666) directly into a 2-inch diameter clear PVC column. The flow rate of air through the column was measured and controlled with a variable area flow meter (Dwyer RMA-SSV). For the purposes of this experiment, it was determined that a flow rate of 200 cubic centimeters per minute (0.0033 L/s) was appropriate based on preliminary trials. In order to conduct the foaming capacity experiment, a sample volume of approximately 300 mL was poured into the column and the initial level was recorded based on measuring tape placed on the columns. The sample was then aerated through a cylindrical air stone at 0.0033 L/s until a steady state height was reached or the foam layer reached the maximum height of the column. The time of aeration was recorded along with the height of foam produced and the level of the foam-liquid interface. A foaming capacity index was calculated as the height of foam produced divided by the initial manure level and multiplied by a factor of 100. The foam stability measurement occurred immediately after the foaming capacity was determined. Once aeration ceased, the final height of foam became the initial level recorded at time zero. Once this level was established, the descending height of the foam was recorded at expanding time intervals. Simultaneously, the ascending level of the foam-liquid interface was recorded at the same time intervals. The descending height of foam was normalized to percent of initial foam height and plotted as a function of time. A first-order exponential decay model fit the data well in most cases. The foaming capacity was calculate by:

$$foaming capacity = \frac{steady state height - initial height}{initial height} * 100 \%$$

The half-life of the foam was used as a measure of stability and determined by:

$${t}_{\frac{1}{3}} = \frac{ln ( 2 )}{decay coefficient k}$$

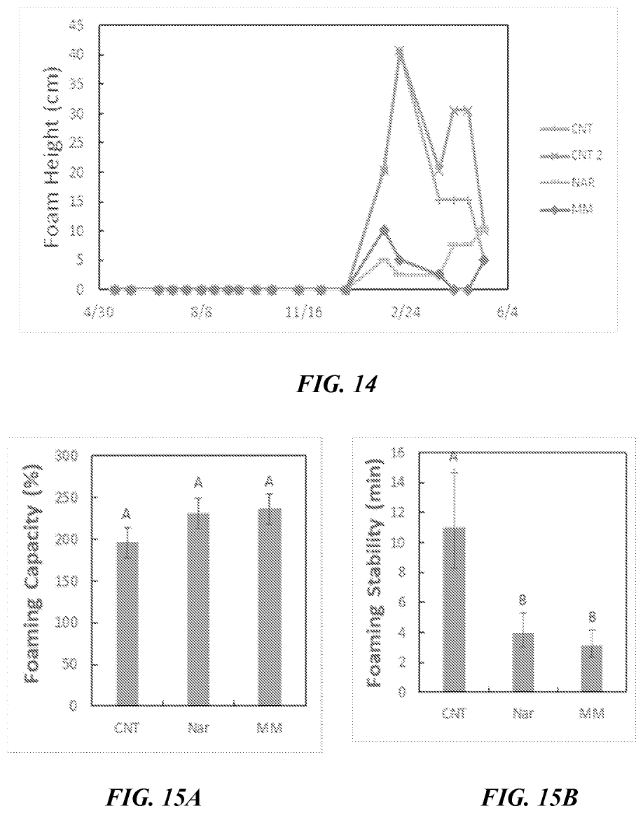

FIG. 14 shows the foam height measured approximately every two weeks over a one year period in two control pits, a pit containing ManureMagic®, and a pit containing Narasin. In the first approximately six months of the study, all the pits showed no accumulation of foam. After approximately six months, the control pits showed a maximum foam accumulation of about 41 centimeters (cm). The pits treated with ManureMagic® and Narasin showed a maximum foam accumulation of approximately 10 cm.

FIGS. 15A and 15B show the percent foaming capacity and foaming stability, respectively, The foaming capacity of the control barn trended lower (CNT=195.9%) than the two treated barns (NAR=231.0%, MM=236.5%), however, none of the pits were statistically different. The control pit had a significantly higher foaming stability (CNT=11.0 minute) than both treated pits (NAR=4.0 minutes, MM=3.1 minutes), however, the Narasin treated pit and the ManureMagic® treated pit did not have a statistical difference.

While preferred embodiments have been shown and described herein, it will be obvious to those skilled in the art that such embodiments are provided by way of example only. Numerous variations, changes, and substitutions may now occur. It should be understood that various alternatives to the embodiments described herein can be employed in practicing the described methods. It is intended that the following claims define the scope of the embodiments and that methods and structures within the scope of these claims and their equivalents be covered thereby.

1.-84. (canceled)

85. A method of decreasing a concentration of noxious materials in a manure comprising:
(a) providing a quantity of manure and an inert porous medium loaded with at least one microbial species; and
(b) applying an effective amount of the inert porous medium loaded with the at least one microbial species to the quantity of manure, wherein the inert porous medium loaded with the at least one microbial species decreases the noxious materials concentration in the quantity of manure as compared to a quantity of manure without the inert porous medium with the at least one microbial species.

86. The method of claim 85, wherein the noxious materials comprises hydrogen sulfide, methane, carbon dioxide, nitrous oxide, odors, toxins, ammonia, or any combination thereof.

87. The method of claim 85, further comprising reducing a concentration of noxious gas and odor released from the quantity of manure as compared to a concentration of noxious gas and odor released from a quantity of manure without the inert porous media loaded with the at least one microbial species.

88. The method of claim 87, wherein the noxious gas and odor comprises hydrogen sulfide, ammonia, methane, nitrous oxide, carbon dioxide, or combinations thereof.

89. The method of claim 85, wherein the inert porous medium comprises particles having diameters from about 10 micrometers to about 1400 micrometers, and optionally pores with an average diameter from about 5 nanometers to about 30 micrometers.

90. The method of claim 85, wherein the inert porous medium loaded with the at least one microbial species is applied to the quantity of manure at a predetermined time interval.

91. The method of claim 85, wherein the at least one microbial species is a consortium of microorganisms.

92. The method of claim 85, wherein the inert porous medium loaded with the at least one microbial species is applied to the quantity of manure at a ratio from about 0.025 grams-to-cubic meters to about 1.0 kilogram-to-cubic meters.

93. The method of claim 85, wherein the at least one microbial species is combined with a culture media to form a microbial solution and wherein the microbial solution is loaded onto the inert porous medium.

94. The method of claim 93, wherein the inert porous medium loaded with the microbial solution has the consistency of a free flowing powder with a mass ratio of the inert porous medium to the microbial solution from about 0.25 to about 10.

95. The method of claim 85, wherein the inert porous medium comprises silica, zeolite, diatomaceous earth, activated alumina, activated carbon, graphite, synthetic polymers, or any combination thereof.

96. The method of claim 85, wherein the concentration of noxious materials in the manure is decreased by about 15% to about 75%, as compared to a manure without the inert material loaded with the at least one microbial species.

97. A composition comprising a quantity of manure and an inert porous medium loaded with at least one microbial species, wherein the quantity of manure has a decreased concentration of noxious materials as compared to a manure without the inert porous medium loaded with at least one microbial species.

98. The composition of claim 97, wherein the noxious materials comprise ammonia, hydrogen sulfide, methane, carbon dioxide, nitrous oxide, odors, toxins, or any combinations thereof.

99. The composition of claim 97, wherein the inert porous medium comprises particles having diameters from about 10 micrometers to about 1400 micrometers, and optionally pores with an average diameter from about 5 nanometers to about 30 micrometers.

100. The composition of claim 97, wherein the at least one microbial species is a consortium of microorganisms.

101. The composition of claim 97, wherein the at least one microbial species is combined with a culture media to form a microbial solution and wherein the microbial solution is loaded onto the inert porous medium.

102. The composition of claim 101, wherein the inert porous medium loaded with the microbial solution has the consistency of a free flowing powder with a mass ratio of the inert porous medium to the microbial solution from about 0.25 to about 10.

103. The composition of claim 97, wherein the concentration of noxious materials is decreased by about 15% to about 75%, as compared to a manure without the inert porous material loaded with the at least one microbial species.

104. The composition of claim 97, wherein the inert porous medium comprises silica, zeolite, diatomaceous earth, activated alumina, activated carbon, graphite, synthetic polymers, or any combination thereof.
